(19) United States
(12) Patent Application Publication
(10) Pub. No.: US 2003/0187678 A1
(43) Pub. Date: Oct. 2, 2003

(54) Method of and apparatus for supporting personnel skill enhancement plan, and computer product

(75) Inventors: Hiroshi Inagawa, Tokyo (JP); Akio Fujino, Tokyo (JP); Hiroshi Hatakama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/270,201

(22) Filed: Oct. 15, 2002

(30) Foreign Application Priority Data
Mar. 29, 2002 (JP) 2002-097512

(51) Int. Cl. G06F 17/60

(52) U.S. Cl. 705/1

(57) ABSTRACT

A personnel skill enhancement plan supporting apparatus includes a necessary skill input section that inputs a necessary skill, a difference keyword extracting section that extracts a difference keyword indicating a not-yet-mastered skill between learning keywords of the input skill and keywords mastered by a target member, a target member extracting section that extracts a target member having a smallest number of extracted difference keywords, a module extracting section that extracts a teaching material module, an essential keyword extracting section that extracts essential keywords of the extracted module, a lacked essential keyword extracting section that extracts a lacked essential keyword, and a learnable module extracting section that extracts a module in which the number of lacked essential keywords is zero.

### BACKGROUND OF THE INVENTION

1) Field of the Invention

The present invention relates to a personnel skill enhancement plan supporting method, a personnel skill enhancement plan supporting program, and a personnel skill enhancement plan supporting that support the skill enhancement plan of personnel.

2) Description of the Related Art

In recent years, there has been an increasing need for organizations like companies to plan skill enhancement of their personnel because each organization requires combinations of personnel having a plurality of skills necessary to achieve objects of the organization.

However, in order to plan an optimum personnel skill enhancement system to build up combinations of the personnel required for each organization, it is necessary to calculate all combinations of skills to be enhanced and personnel to be trained. When the number of personnel increases, the calculation becomes huge, which makes it difficult to execute the calculations. Further, it is not easy to know the learning time and lecture attendance fees of each member prior to the start of lectures. Therefore, it is also difficult to properly plan the personnel skill enhancement by taking timings and budget into account.

### SUMMARY OF THE INVENTION

It is an object of the present invention to provide a personnel skill enhancement plan supporting method, a personnel skill enhancement plan supporting program, and a personnel skill enhancement plan supporting capable of efficiently and easily extracting most suitable personnel whose skills are to be enhanced from among a plurality of members and capable of extracting optimum teaching materials to be learned.

In order to achieve the object of the present invention by solving the above problems, according to one aspect of the invention, there are provided the personnel skill enhancement plan supporting method, the personnel skill enhancement plan supporting program and the personnel skill enhancement plan supporting apparatus that execute the following respectively. When information relating to a necessary skill has been input, a difference keyword is extracted for each member. More specifically, a difference keyword as a keyword indicating a not-yet-mastered skill that is a keyword linked with the skill relating to the input information but not a keyword linked with a skill already mastered by the target member to be extracted, is extracted. Then, information relating to a member who has a smallest number of difference keywords that have been extracted is extracted.

According to the above aspect of the invention, members are selected based on a difference between mastered keywords and keywords to be learned, as a difference keyword that is a keyword indicating a not-yet-mastered skill. Based on this, it is possible to obtain an optimum solution from a calculation of only the number of necessary skills.

According to another aspect of the invention, there are provided the personnel skill enhancement plan supporting method, the personnel skill enhancement plan supporting program and the personnel skill enhancement plan supporting apparatus that execute the following respectively. When information relating to a necessary skill has been input, a difference keyword is extracted for each member. More specifically, a difference keyword as a keyword indicating a not-yet-mastered skill that is a keyword linked with the skill relating to the input information but not a keyword linked with a skill already mastered by the target member to be extracted, is extracted. A module linked with keywords that coincide with the whole or a part of the difference keywords extracted, is extracted out of the information relating to modules obtained by subdividing a teaching material. An essential keyword linked with the contents that are supposed to be mastered in advance is extracted in order to master the contents of the module extracted. A lacked essential keyword that is an essential keyword extracted but not a keyword linked with the skill already mastered by the member, is extracted as a keyword indicating a not-yet-mastered essential skill. Then, a module is extracted as a learnable module when the number of lacked essential keywords extracted is zero.

According to the above aspect of the invention, it is possible to provide information such as a learning time, a fee, suitability or unsuitability of lecture attendance, and other recommendable lectures, etc.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is an explanatory diagram which shows one example of a system structure of a personnel skill enhancement plan supporting system that includes a personnel skill enhancement plan supporting apparatus according to an embodiment of the present invention,

FIG. 2 is an explanatory diagram which shows a part of a data layout of a teaching material database 104,

FIG. 3 is an explanatory diagram which shows a part of a data layout of a skill keyword database 105,

FIG. 4 is an explanatory diagram which shows a part of a data layout of a lecture attendance record database 106,

FIG. 5 is an explanatory diagram which shows a part of a data layout of a table of necessary skills 111,

FIG. 6 is an explanatory diagram which shows a part of a data layout of a table of members and lecture modules to be attended 112,

FIG. 7 is an explanatory diagram which shows a part of a data layout of a table of keywords yet to be mastered by members 113,

FIG. 8 is an explanatory diagram which shows a part of a data layout of a table of necessary skill keywords 121,

FIG. 9 is an explanatory diagram which shows a part of a data layout of a table of difference keywords 122,

FIG. 10 is an explanatory diagram which shows a part of a data layout which is a matrix for numbers of difference keywords 123,

FIG. 11 is an explanatory diagram which shows a part of a data layout of a table of members assigned to skills 124,

FIG. 12 is a block diagram which shows one example of a hardware structure of an information processing server 101 as a personnel skill enhancement plan supporting apparatus according to the embodiment of the present invention and information processing terminal devices 102 and 103,

FIG. 13 is a block diagram which shows one example of a functional structure of the information processing server 101 as the personnel skill enhancement plan supporting apparatus according to the embodiment,

FIG. 14 is a flowchart which shows the contents of the whole processing of a member extraction of the personnel skill enhancement plan supporting apparatus according to the embodiment,

FIG. 15 is a flowchart which shows the contents of an extraction processing of lacked keywords for each necessary skill and for each member in the personnel skill enhancement plan supporting apparatus according to the embodiment,

FIG. 16 is a flowchart which shows the contents of processing for extracting a member requiring skill enhancement for each necessary skill in the personnel skill enhancement plan supporting apparatus according to the embodiment,

FIG. 17 is a flowchart which shows the contents of processing for a module lecture attendance planning for a member requiring skill enhancement in the personnel skill enhancement plan supporting apparatus according to the embodiment of the present invention,

FIG. 18 is an explanatory diagram which shows one example of a screen displaying the determination result of modules to be attended,

FIG. 19 is an explanatory diagram which shows another example of a screen displaying the determination result of modules to be attended,

FIG. 20 is an explanatory diagram which shows still another example of a screen displaying the determination result of modules to be attended,

FIG. 21 is an explanatory diagram which shows still another example of a screen displaying the determination result of modules to be attended,

FIG. 22 is an explanatory diagram which shows an outline of a lecture attendance simulation in the personnel skill enhancement plan supporting apparatus according to the embodiment,

FIG. 23 is another explanatory diagram which shows the outline of the lecture attendance simulation in the personnel skill enhancement plan supporting apparatus according to the embodiment,

FIG. 24 is still another explanatory diagram which shows the outline of the lecture attendance simulation in the personnel skill enhancement plan supporting apparatus according to the embodiment,

FIG. 25 is still another explanatory diagram which shows the outline of the lecture attendance simulation in the personnel skill enhancement plan supporting apparatus according to the embodiment,

FIG. 26 is still another explanatory diagram which shows the outline of the lecture attendance simulation in the personnel skill enhancement plan supporting apparatus according to the embodiment,

FIG. 27 is still another explanatory diagram which shows the outline of the lecture attendance simulation in the personnel skill enhancement plan supporting apparatus according to the embodiment,

FIG. 28 is still another explanatory diagram which shows the outline of the lecture attendance simulation in the personnel skill enhancement plan supporting apparatus according to the embodiment,

FIG. 29 is still another explanatory diagram which shows the outline of the lecture attendance simulation in the personnel skill enhancement plan supporting apparatus according to the embodiment,

FIG. 30 is still another explanatory diagram which shows the outline of the lecture attendance simulation in the personnel skill enhancement plan supporting apparatus according to the embodiment,

FIG. 31 is still another explanatory diagram which shows the outline of the lecture attendance simulation in the personnel skill enhancement plan supporting apparatus according to the embodiment,

FIG. 32 is a flowchart which shows the contents (part one) of the whole processing of the lecture attendance simulation in the personnel skill enhancement plan supporting apparatus according to the embodiment,

FIG. 33 is a flowchart which shows the contents (part two) of the whole processing of the lecture attendance simulation in the personnel skill enhancement plan supporting apparatus according to the embodiment,

FIG. 34 is an explanatory diagram which shows a part of a data layout of a lecture database 108,

FIG. 35 is an explanatory diagram which shows a part of a data layout of a table of learning keywords for work 125,

FIG. 36 is an explanatory diagram which shows a part of a data layout of a learning record database 107,

FIG. 37 is an explanatory diagram which shows a part of a data layout of a table of mastered keywords for work 126,

FIG. 38 is a flowchart which shows the contents of processing for extracting a candidate module of the lecture attendance simulation in the personnel skill enhancement plan supporting apparatus according to the embodiment,

FIG. 39 is an explanatory diagram which shows a part of a data layout of a module database 109, and

FIG. 40 is an explanatory diagram which shows a part of a data layout of a table of learning modules 127.

### DETAILED DESCRIPTION

Embodiments of the personnel skill enhancement plan supporting method, the personnel skill enhancement plan supporting program, and the personnel skill enhancement plan supporting apparatus according to the present invention will be explained in detail below with reference to the attached drawings.

[System Structure of the Personnel Skill Enhancement Plan Supporting Apparatus]

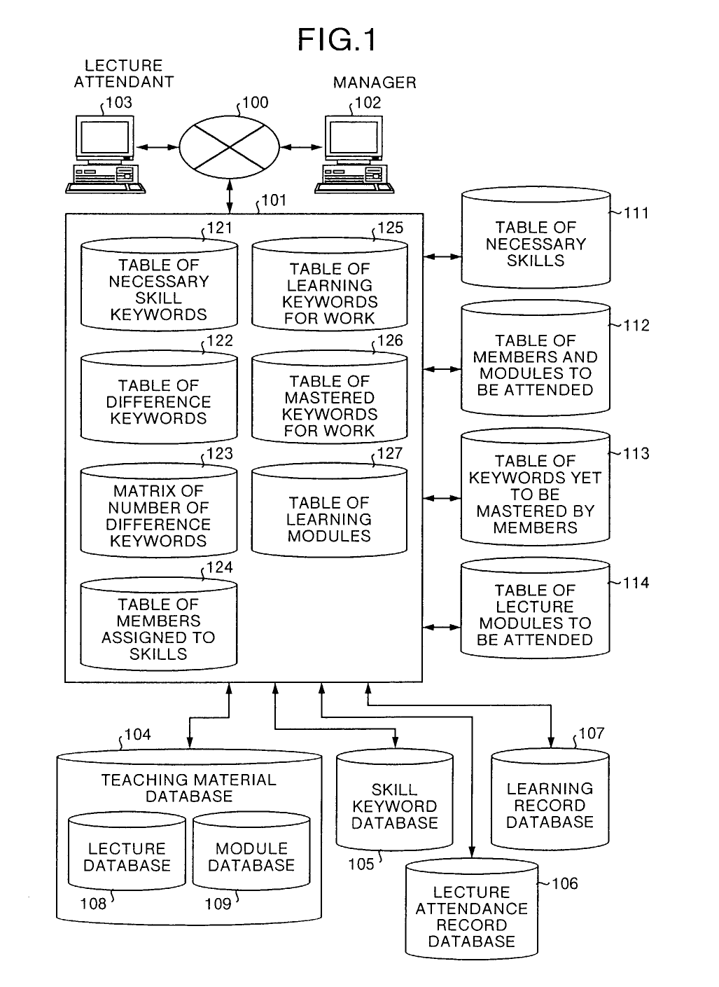

A system structure of a personnel skill enhancement plan supporting system that includes the personnel skill enhancement plan supporting apparatus according to the embodiment of the present invention will be explained first. FIG. 1 is an explanatory diagram which shows one example of the system structure of the personnel skill enhancement plan supporting system that includes the personnel skill enhancement plan supporting apparatus according to the embodiment. In FIG. 1, a reference numeral 100 denotes a network like the Internet, 101 denotes an information processing server as the personnel skill enhancement plan supporting apparatus, 102 denotes an information processing terminal device for managers, and 103 denotes an information processing terminal device for lecture attendants.

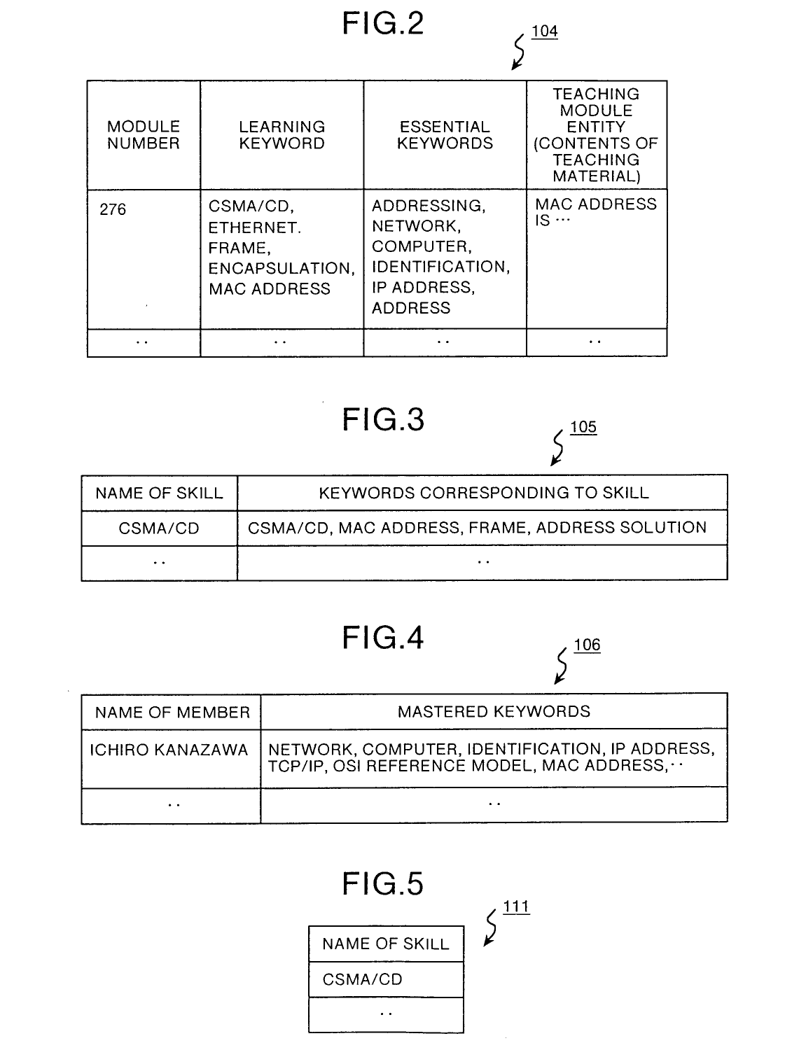

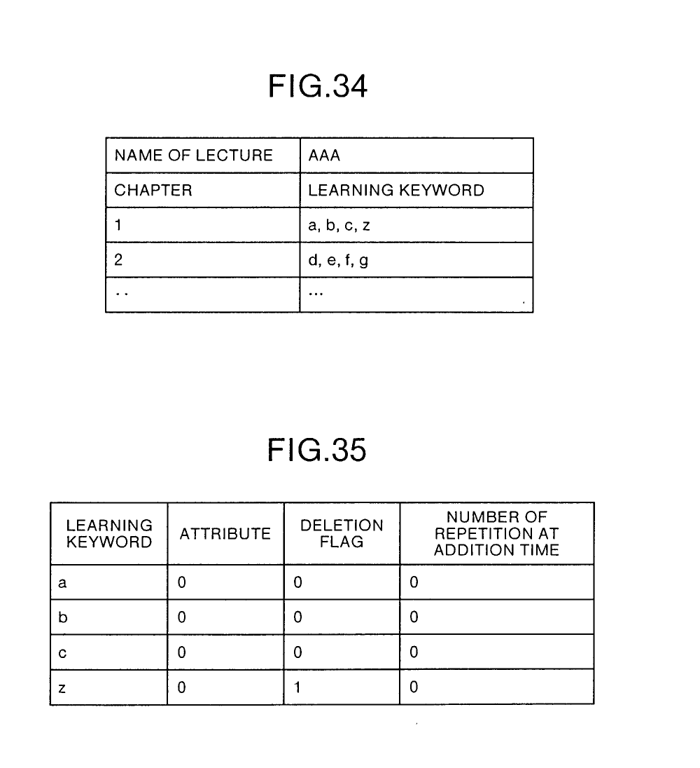

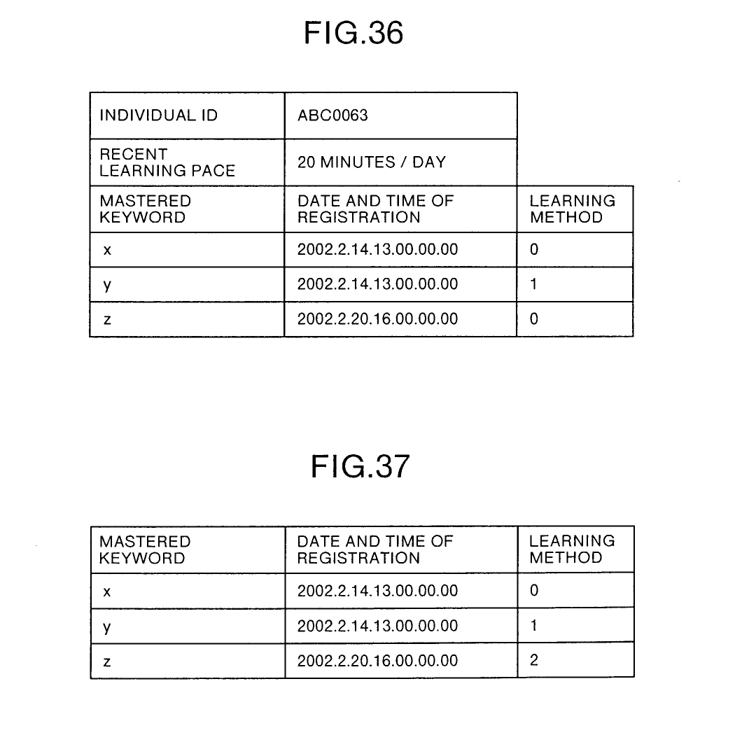

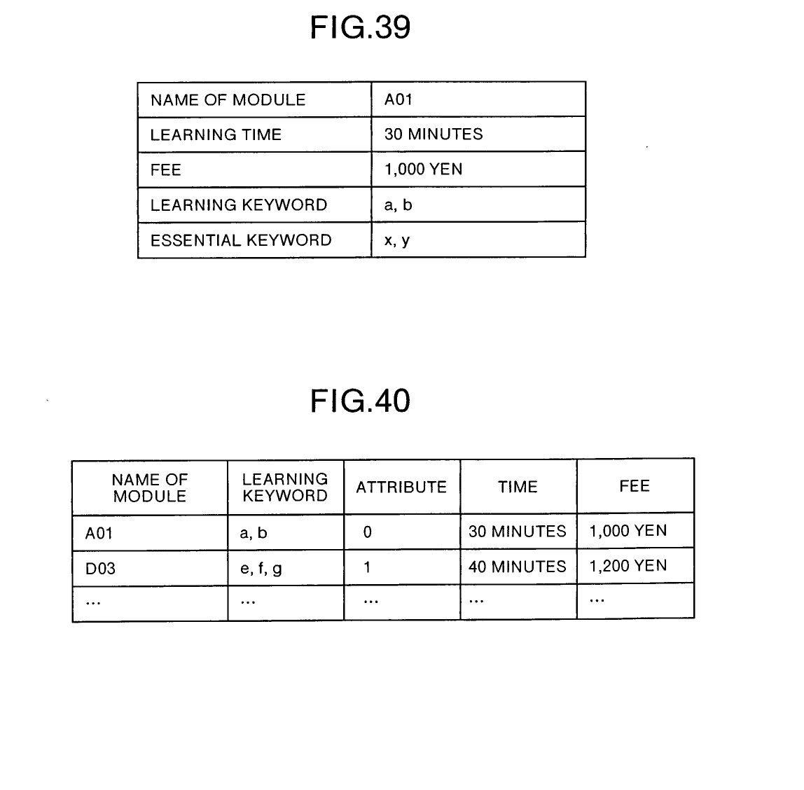

A reference numeral 104 denotes a teaching material database having a data layout as shown in FIG. 2. A reference numeral 105 denotes a skill keyword database having a data layout as shown in FIG. 3. A reference numeral 106 denotes a lecture attendance record database having a data layout as shown in FIG. 4. A reference numeral 107 denotes a learning record database as shown in FIG. 36. The teaching material database 104 includes a lecture database 108 as shown in FIG. 34 and a module database 109 as shown in FIG. 39.

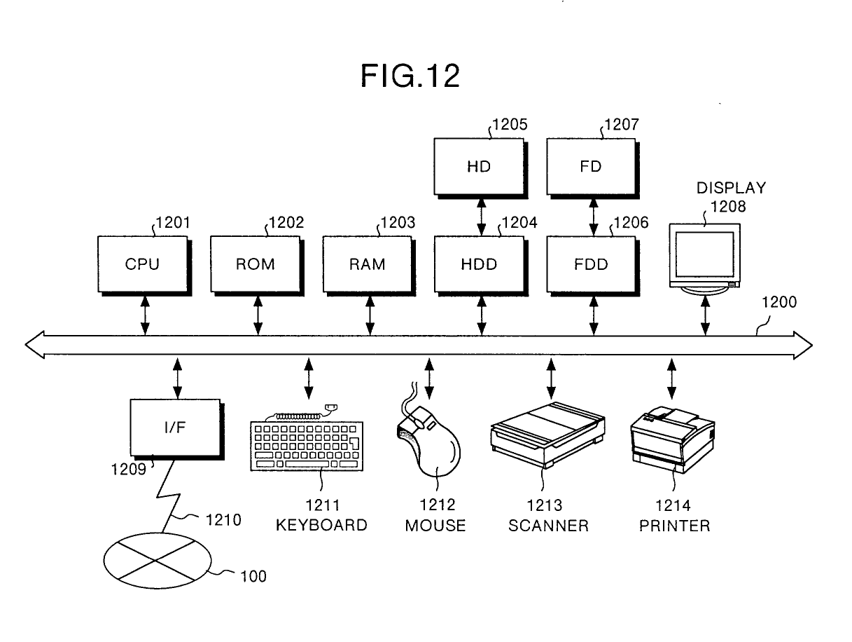

The respective databases of the teaching material database 104, the skill keyword database 105, the lecture attendance record database 106, the learning record database 107, the lecture database 108, and the module database 109 realize their functions based on a ROM 1202, a RAM 1203, an HD 1205, and an FD 1207 to be described later as shown in FIG. 12, for example. The contents of each data layout of the databases will be explained later.

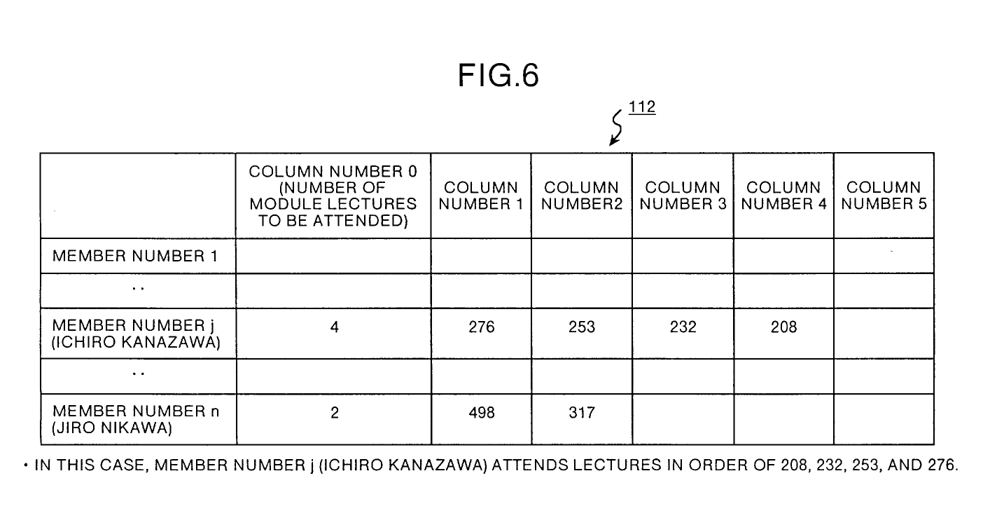

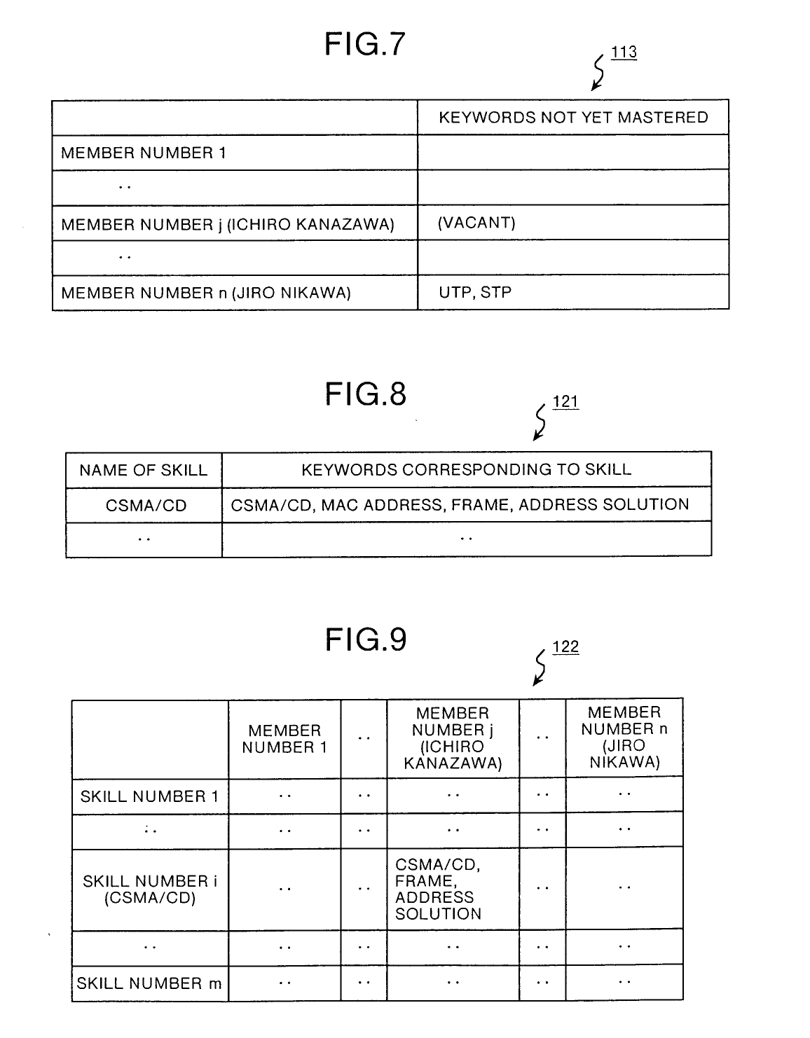

A reference numeral 111 denotes a table of necessary skills having a data layout as shown in FIG. 5. A reference numeral 112 denotes a table of members and modules to be attended having a data layout as shown in FIG. 6. A reference numeral 113 denotes a table of keywords yet to be mastered by members having a data layout as shown in FIG. 7. A reference numeral 114 denotes table of lecture modules to be attended.

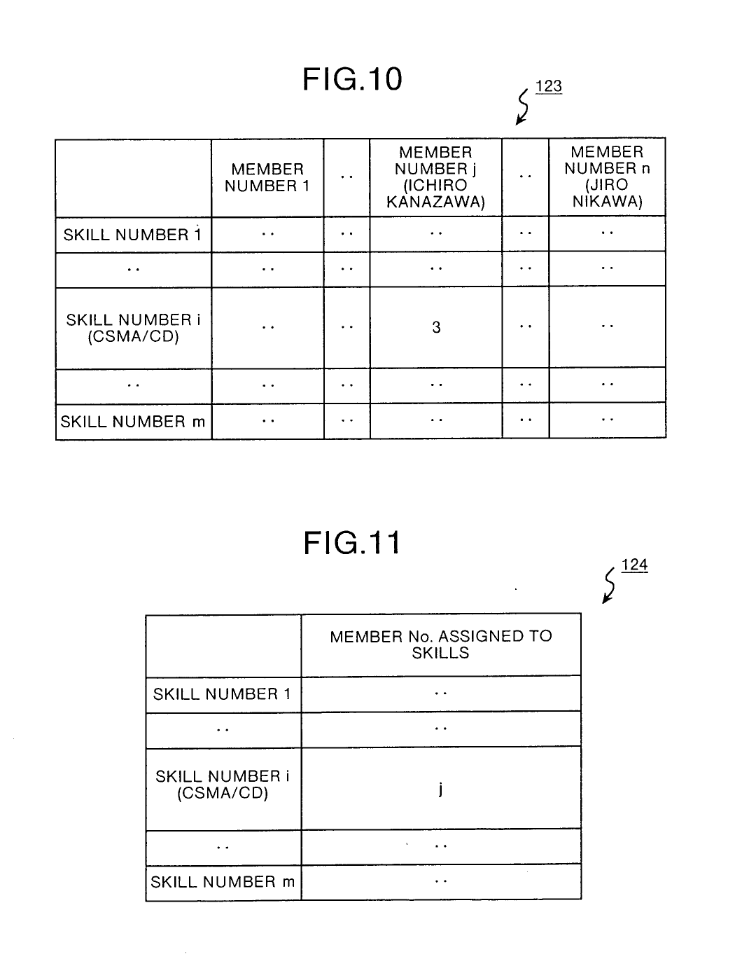

A reference numeral 121 denotes a table of necessary skill keywords having a data layout as shown in FIG. 8. A reference numeral 122 denotes a table of difference keywords having a data layout as shown in FIG. 9. A reference numeral 123 denotes a matrix for numbers of difference keywords having a data layout as shown in FIG. 10. A reference numeral 124 denotes a table of members assigned to skills having a data layout as shown in FIG. 11. A reference numeral 125 denotes a table of learning keywords for work having a data layout as shown in FIG. 35. A reference numeral 126 denotes a table of mastered keywords for work having a data layout as shown in FIG. 37. A reference numeral 127 denotes a table of learning modules having a data layout as shown in FIG. 40.

The table of necessary skills 111, the table of members and modules to be attended 112, the table of keywords yet to be mastered by members 113, the table of lecture modules to be attended 114, the table of necessary skill keywords 121, the table of difference keywords 122, the matrix for numbers of difference keywords 123, the table of members assigned to skills 124, the table of learning keywords for work 125, the table of mastered keywords for work 126, and the table of learning modules 127 respectively realize their functions based on the RAM 1203, the HD 1205, and the FD 1207 as shown in FIG. 12 to be described later, for example. The contents of each data layout of the databases will be explained later.

[Hardware Structure of the Information Processing Server 101 and the Information Processing Terminal Devices 102 and 103)

A hardware structure of the information processing server 101 as the personnel skill enhancement plan supporting apparatus according to the embodiment of the present invention and the information processing terminal devices 102 and 103 will be explained next. FIG. 12 is a block diagram which shows one example of the hardware structure of the information processing server 101 and the information processing terminal devices 102 and 103.

In FIG. 12, the information processing server 101 and the information processing terminal devices 102 and 103 have a CPU 1201, the ROM 1202, the RAM 1203, an HDD (hard disk drive) 1204, the HD (hard disk) 1205, an FDD (flexible disk drive) 1206, the FD (flexible disk) 1207 as one example of a detachable recording medium, a display 1208, an I/F (interface) 1209, a keyboard 1211, a mouse 1212, a scanner 1213, and a printer 1214. Each of these constituent elements is connected to one another via a bus 1200.

The CPU 1201 controls the whole of the information processing server 101 or the information processing terminal devices 102 and 103. The ROM 1202 stores programs such as a boot program. The RAM 1203 is used as a work area of the CPU 1201. The HDD 1204 controls reading/writing of data from/to the HD 1205 according to the control of the CPU 1201. The HD 1205 stores data written under the control of the HDD 1204.

The FDD 1206 controls reading/writing of data from/to the FD 1207 according to the control of the CPU 1201. The FD 1207 stores data written under the control of the FDD 1206, or makes the information processing device read data stored in the FD 1207. A detachable recording medium may be a CD-ROM (CD-R, CD-RW), an MO, a digital versatile disk (DVD), or a memory card, in addition to the FD 1207. The display 1208 displays windows (browser) relating to documents, images and functional information, as well as a cursor, icons, and a tool box. The display 1208 is, for example, a CRT, a TFT liquid crystal display, or a plasma display.

The I/F (interface) 1209 is connected to the network 100 like a LAN and the Internet via a communication line 1210, and is connected to other servers and information processing devices. The I/F 1209 takes interface between the network 100 and the inside of the device, and controls inputting/outputting of data to/from the other servers and information terminal devices. The I/F 1209 is a modem, for example.

The keyboard 1211 has keys for inputting characters, numbers, and instructions, and is used to input data. The keyboard 1211 may be a touch panel type input pad or a ten-digit keypad. The mouse 1212 is used to move the cursor, select a range, move windows, or change sizes. Instead of the mouse 1212, there may be used other pointing device which has a similar function, such as a track ball, a joystick, a cross key, or a jog dial.

The scanner 1213 optically reads images, and captures image data into the information processing device. The printer 1214 prints image data and document data. For example, the printer 1214 is a laser printer or an ink-jet printer.

The terminal devices 102 and 103 may be personal computers, or portable information processing terminals such as portable telephones, for example. When the terminal devices 102 and 103 are portable telephones, the I/F 1209 controls transmission/reception of waves to/from a radio base station not shown to be connected to the network 100, and connected to the information processing server 101 via the network 100. The I/F 1209 takes interface between the network 100 and the inside of the device, and controls inputting/outputting of data to/from the other information processing servers. The terminal devices 102 and 103 may be also provided with a microphone and a speaker not shown that realize a function of a telephone. The microphone converts voice into an electric signal, and inputs this signal. The speaker outputs the voice.

[Functional Structure of the Information Processing Server 101]

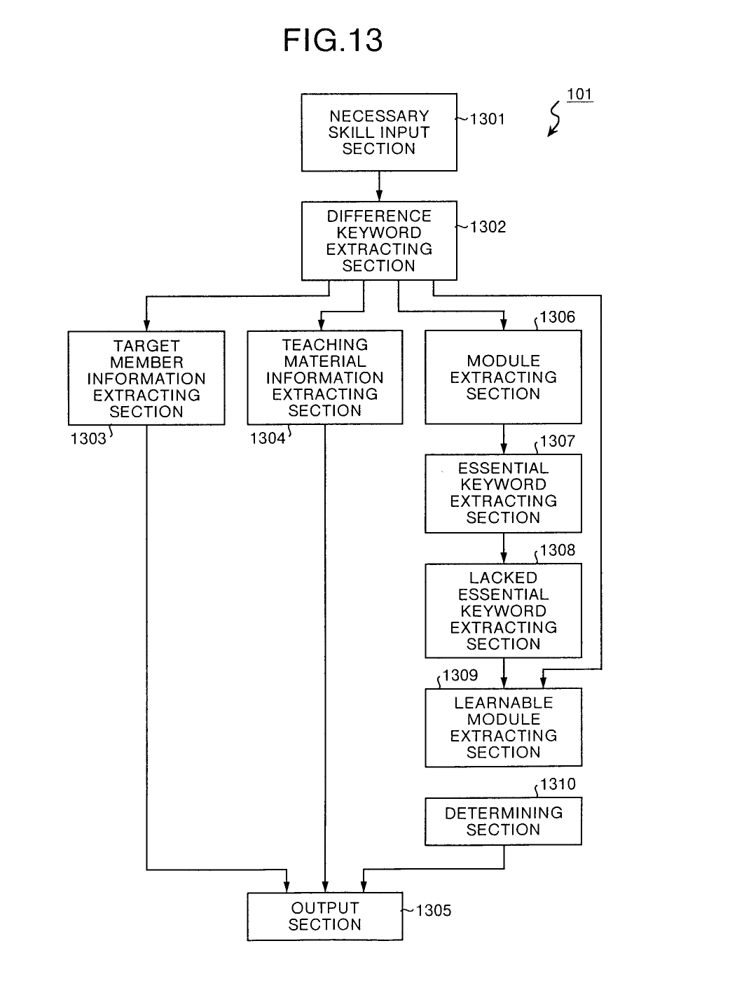

A functional structure of the information processing server as the personnel skill enhancement plan supporting apparatus according to the embodiment of the present invention will be explained. FIG. 13 is a block diagram which shows one example of the functional structure of the information processing server 101.

In FIG. 13, the information processing server 101 includes a necessary skill input section 1301, a difference keyword extracting section 1302, a target member information extracting section 1303, a teaching material information extracting section 1304, an output section 1305, a module extracting section 1306, an essential keyword extracting section 1307, a lacked essential keyword extracting section 1308, a learnable module extracting section 1309, and a determining section 1310.

The necessary skill input section 1301 inputs information relating to necessary skills. For example, the necessary skill input section 1301 realizes its function with the I/F 1209 shown in FIG. 12. Alternatively, the necessary skill input section 1301 may also realize its function with the keyboard 1211. Further, the necessary skill input section 1301 may also realize its function by inputting necessary skill information described on paper with the scanner 1213, and changing an image of the input necessary skill information into data using an OCR function not shown.

The difference keyword extracting section 1302 extracts, for each member, a difference keyword that is a keyword (a keyword corresponding to the skill in the table of necessary skill keywords 121) linked with the skill relating to the information input by the necessary skill input section 1301 and not a keyword (a mastered keyword in the lecture attendance record database 106) linked with the skill already mastered by the target member to be extracted. Then, the difference keyword extracting section 1302 records the extracted difference keyword onto the table of difference keywords 122.

The target member information extracting section 1303 extracts numbers of difference keywords extracted by the difference keyword extracting section 1302, from the matrix for numbers of difference keywords 123. The target member information extracting section 1303 extracts information relating to a target member who has a smallest number of difference keywords out of the extracted numbers, and records this information onto the table of members assigned to skills 124.

The teaching material information extracting section 1304 extracts information relating to a teaching material linked with keywords that coincide with the whole or a part of the difference keywords extracted by the difference keyword extracting section 1302, by using the teaching material database 104.

The output section 1305 stores information relating to a target member extracted by the target member information extracting section 1303 and information relating to a teaching material extracted by the teaching material information extracting section 1304, for each target member, into the table of lecture modules to be attended 114. Then, the output section 1305 outputs the stored information. The information stored in the table of lecture modules to be attended 114 is displayed by the display 1208 or printed by the printer 1214 shown in FIG. 12, for example. Further, the information stored in the table of lecture modules to be attended 114 is transmitted to the manager's information processing terminal device 102, and the lecture attendant's information processing terminal device 103, through the I/F 1209 via the network 100. Therefore, the output section 1305 realizes its function with the display 1208, the I/F 1209, and the printer 1214.

The module extracting section 1306 extracts from the module database 109 a module linked with keywords that coincide with the whole or a part of the difference keywords extracted by the difference keyword extracting section 1302, out of the information relating to modules obtained by subdividing the teaching material within the module database 109.

The essential keyword extracting section 1307 extracts from the module database 109 an essential keyword linked with contents that are supposed to be mastered in advance in order to learn the contents of the module extracted by the module extracting section 1306.

The lacked essential keyword extracting section 1308 extracts a lacked essential keyword that is an essential keyword extracted by the essential keyword extracting section 1307 but is not yet mastered by the target member (not a mastered keyword in the table of mastered keywords for work 126).

The learnable module extracting section 1309 extracts a module as a learnable module when the number of not-yet-mastered essential keywords (“number of lacked essential keywords” of a candidate record shown in FIG. 28 to be described later) extracted by the lacked essential keyword extracting section 1308 is zero.

When there are a plurality of modules in which the number of lacked essential keywords extracted by the lacked essential keyword extracting section 1308 is zero among the modules extracted by the module extracting section 1306, the learnable module extracting section 1309 extracts a module including a largest number of not-yet-mastered keywords, i.e., difference keywords that have been extracted by the difference keyword extracting section 1302. With this arrangement, when one lecture is attended, lacked essential keywords can be changed as mastered keywords as many as possible. Therefore, it is possible to provide an efficient order of lecture attendance.

The determining section 1310 determines at least one of a lecture attendance fee and a lecture attendance period of a target member based on the table of learning modules 127 in which the learnable module extracted by the learnable module extracting section 1309 has been recorded. The output section 1305 outputs information on at least one of the lecture attendance fee and the lecture attendance period of the member determined by the determining section 1310.

The difference keyword extracting section 1302, the target member information extracting section 1303, the teaching material information extracting section 1304, the module extracting section 1306, the essential keyword extracting section 1307, the lacked essential keyword extracting section 1308, the learnable module extracting section 1309, and the determining section 1310 realize their functions respectively based on the execution of programs stored in the ROM 1202, the RAM 1203, the HD 1205, or the FD 1207 shown in FIG. 12, by the CPU 1201.

[Whole Contents of Processing for Member Extraction in the Personnel Skill Enhancement Plan Supporting Apparatus]

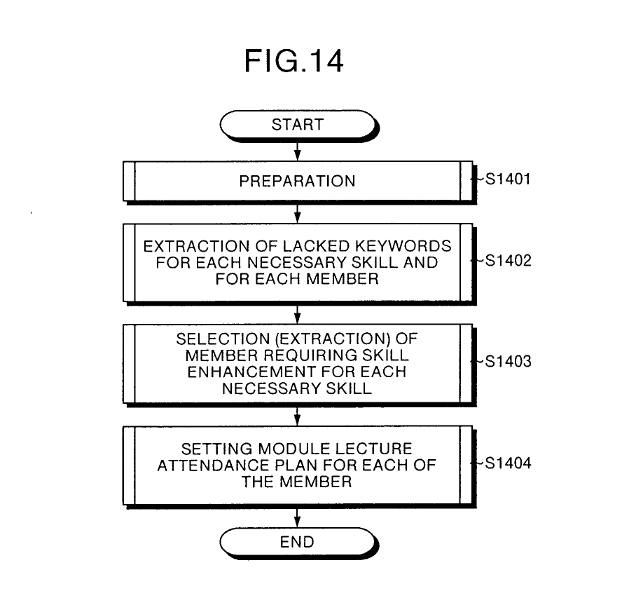

The flow of the whole processing of a member extraction in the personnel skill enhancement plan supporting apparatus will be explained below. FIG. 14 is a flowchart which shows the contents of the whole processing of a member extraction in the personnel skill enhancement plan supporting apparatus according to the embodiment of the present invention. In the flowchart shown in FIG. 14, various kinds of preparation are carried out first (step S1401). Next, lacked keywords are extracted for each necessary skill and for each member (step S1402), and a member requiring skill enhancement is selected (extracted) for each necessary skill (step S1403). A module lecture attendance plan is set for each member requiring skill enhancement (step S1404). The contents of the above steps will be explained sequentially in detail.

[Contents of the Preparation]

The contents of the preparation at step S1401 will be explained first. A skill enhancement course is prepared in a relatively small unit called a module. Each module has a keyword obtained based on the attendance of a lecture of the module (hereinafter to be referred to as a “learning keyword”), and a keyword that needs to be learned prior to the attendance of the lecture of this module (hereinafter to be referred to as an “essential keyword”). These key words are described in the teaching material database 104 shown in FIG. 2.

A name of a skill obtained based on the attendance of a lecture of each module will be called a title. The title may coincide with the learning keyword of the module.

All target members to be selected have a lecture attendance record on the lecture attendance record database 106 shown in FIG. 4 respectively. The lecture attendance record has a record of learning keywords obtained by attending skill enhancement lectures in the past and keywords obtained through practical business affairs or self-learning. These keywords will be called “mastered keywords”. When a member has attended a lecture of the module, the learning keyword of the module is automatically recorded on the lecture attendance record database 106 where the mastered keywords are recorded. When a member has mastered a keyword through practical business affairs or self-learning, the member or the superior records this mastered keyword.

The present system has the skill keyword database 105 as shown in FIG. 3. This database describes keywords that constitute one skill (keywords corresponding to a skill).

Manager of an organization extracts skills that are required by the organization. For extracting lacked skills, it is possible to use Japanese Patent Application Laid-open Publication No. 2000-352970 (Enterprise skill enhancement planning method and enterprise skill enhancement information learning method) according to the applicant of the present invention, for example. The extracted skills are recorded onto the table of necessary skills 111 shown in FIG. 5. At the same time, target members to be selected for the skill enhancement are extracted. In the present embodiment, all members in the lecture attendance record database 106 are assumed as candidates for simplicity.

[Contents of Processing for Extraction of Lacked Keywords for Each Necessary Skill and for Each Member]

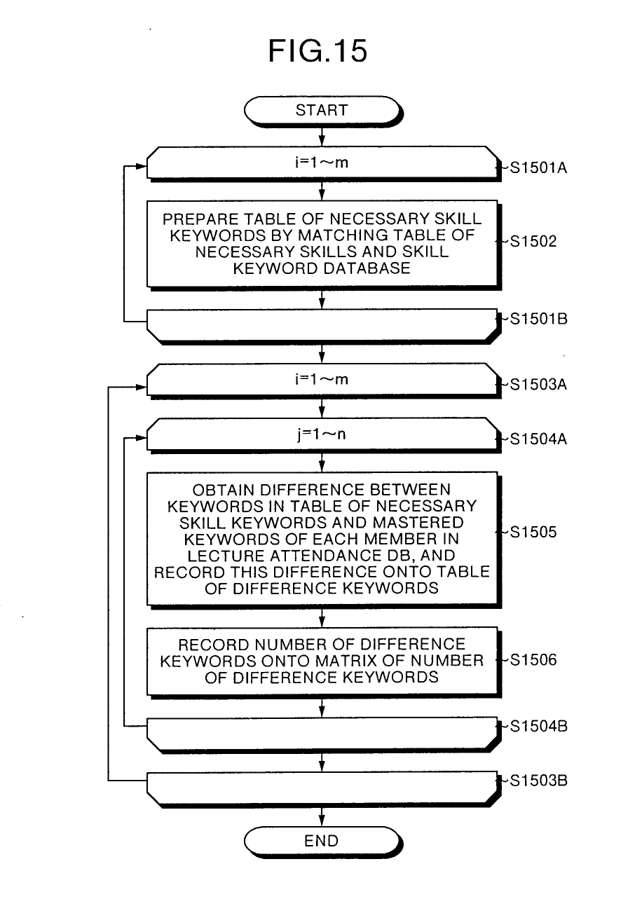

The contents of processing for the extraction of lacked keywords for each necessary skill and for each member shown at step S1402 in FIG. 14 will be explained below. The extraction of lacked keywords for each necessary skill and for each member is automatically processed by the present system. FIG. 15 is a flowchart which shows the contents of the extraction processing of lacked keywords for each necessary skill and for each member in the personnel skill enhancement plan supporting apparatus according to the embodiment of the present invention.

In the subsequent explanation, it is assumed that “m” represents the number of necessary skills (necessary skills are allocated with numbers from 1 to m), and “n” represents the number of members to be selected (extracted) (members are allocated with numbers from 1 to n) (hereinafter, same can be said).

In the flowchart shown in FIG. 15, the table of necessary skill keywords 121 shown in FIG. 8 is prepared by matching the table of necessary skills 111 shown in FIG. 5 and the skill keyword database 105 shown in FIG. 3 (step S1502). This processing is executed for all necessary skills (1 to m) (step S1501A to step S1501B).

A difference between the keywords in the table of necessary skill keywords 121 and the mastered keywords of each member obtained from the lecture attendance record in the lecture attendance record database 106 is recorded onto the table of difference keywords 122 shown in FIG. 9 (step S1505). Elements are expressed as DK (i, j). In FIG. 9, for a member number j (Ichiro Kanazawa), “CSMA/CD”, “frame”, and “address solution” are recorded as difference keywords, regarding a skill number i (CSMA/CD).

The number of difference keywords (the number of lacked keywords) is recorded onto the matrix for numbers of difference keywords 123 (step S1506). When the mastered keywords include all keywords on the table of necessary skill keywords 121, the number of the difference is set to zero. The element of this table is the number of difference keywords, and this is expressed as Num_DK (i, j) (where “i” represents the number of a necessary skill, and “j” represents the number of a member). In FIG. 10, “3” is recorded for the member number j (Ichiro Kanazawa), as there are three difference keywords, “CSMA/CD”, “frame”, and “address solution”, regarding the skill number i (CSMA/CD).

The processing at steps S1505 and S1506 is executed for each item of the table of necessary skill keywords 121. In other words, the processing is executed for all necessary skills (1 to m) (step S1503A to step S1503B), and for all members (1 to n) (step S1504A to step S1504B). Lacked keywords for each necessary skill and for each member are extracted in this way.

[Contents of Processing for Selecting (Extracting) Member Requiring Skill Enhancement for Each Necessary Skill]

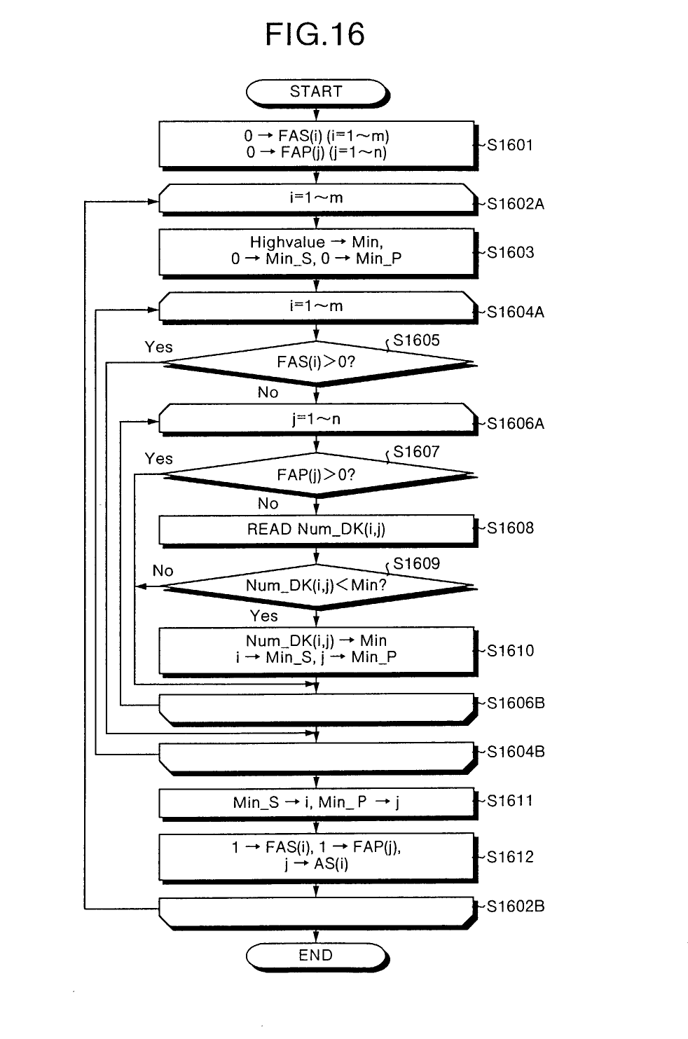

The selection (extraction) of a member requiring skill enhancement for each necessary skill at step S1403 shown in FIG. 14 will be explained below. The selection (extraction) of a member requiring skill enhancement for each necessary skill is also automatically processed by the present system. FIG. 16 is a flowchart which shows the contents of processing for selection (extraction) of a member requiring skill enhancement for each necessary skill in the personnel skill enhancement plan supporting apparatus according to the embodiment of the present invention.

In the flowchart shown in FIG. 16, at step S1601, FAS (i) (i=1 to m) expresses a flag that shows that a member or members requiring skill enhancement for each skill have been selected. Among necessary skills, one for which a member or members requiring skill enhancement have been selected is set with “1”. The other necessary skills are set with “0”. Therefore, “0” is set to all flags at the beginning (step S1601). FAP (j=1 to n) expresses a flag that shows that each target skill for skill enhancement has been assigned to each member. Among members, one to whom a target skill or skills for skill enhancement have been assigned is set with “1”. The other members are set with “0”. Therefore, “0” is set to all flags at the beginning, in a similar manner to that for FAS (i) (step S1601).

Each processing at step S1603 to step S1612 to be described later is executed repeatedly, starting from skill number 1 to skill numbers 2, 3, . . . m in the matrix for numbers of difference keywords 123 shown in FIG. 10 (steps S1602A to step S1602B). At the beginning, a maximum value is set to Min, and “0” is set to Min_S and Min_P respectively (step S1603). When FAS (i) is larger than 0, that is, when a member or members requiring skill enhancement for one out of necessary skills have been selected (Yes at step S1605), no processing is carried out, and the next necessary skill is searched for.

On the other hand, at step S1605, when FAS (i) is not larger than 0, that is, when a member or members requiring skill enhancement for one of necessary skills have not been selected (No at step S1605), then it is determined whether FAP (j) is larger than 0 or not (step S1607). When FAP (j) is larger than 0, that is, when a target skill or skills for skill enhancement have been assigned to a member out of members (Yes at step S1607), no processing is carried out, and a target member to be selected is searched for.

On the other hand, at step S1607, when FAP (j) is not larger than 0, that is, when a target skill or skills for skill enhancement have not been assigned to a member out of the members (No at step S1607), Num_DK (i, j) is read from the matrix for numbers of difference keywords 123 (step S1608). Then, Min is compared with Num_DK (i, j) (step S1609) When Num_DK (i, j) is not smaller than Min (No at step S1609) no processing is carried out, and the next member to be selected is searched for.

On the other hand, when Num_DK (i, j) is smaller than Min at step S1609 (Yes at step S1609), this Num_DK (i, j) is set to Min, and “i” and “j” of this Num_DK (i, j) are set to Min_S and Min_P, respectively (step S1610). As a maximum value has been set to Min at the beginning, Num_DK (i, j) becomes Min without exception. The processing at step S1607 to step S1610 is repeated for members 1 to n (step S1606A to step S1606B). The above processing is further repeated for skill numbers 1 to m (step S1604A to step S1604B).

After all the above processing has been repeatedly carried out, Min_S and Min_P are extracted (step S1611). “1” is set to FAS (i) and FAP (j) corresponding to the extracted “i” and “j” respectively, and the above “j” is recorded onto the table of members assigned to skills 124 shown in FIG. 11 (step S1612). The element of the table of members assigned to skills 124 is expressed as AS (i). The contents of AS (i) show the number of a member who has been assigned to acquire this skill. It is understood from FIG. 11 that “j (Ichiro Kanazawa)” has been recorded as a member number requiring skill enhancement assigned to a skill number i (AS (i)).

In this way, each item in the matrix for numbers of difference keywords (FIG. 10) is processed sequentially in a row (skill) direction. When there is an element that has a value 0 in one row, this element (this may be in a column ascending order) is excluded, and this row and this column (member) are treated as a row and a column to which the assignment has been finished. Thereafter, this row and this column are not searched. This processing is executed until the end of the row (a first processing). Next, an element having a smallest value is searched for, in rows other than the assigned row in the first processing. This becomes a member (column) who should acquire this skill (row). This row and this column are treated as a row and a column to which the assignment has been finished. Thereafter, this row and this column are not searched (a second processing). The second processing is repeated until when the last skill has been assigned in a similar manner. A result of the processing is recorded onto the table of members assigned to skills 124.

[Contents of Setting a Module Lecture Attendance Plan for Each Member Requiring Skill Enhancement]

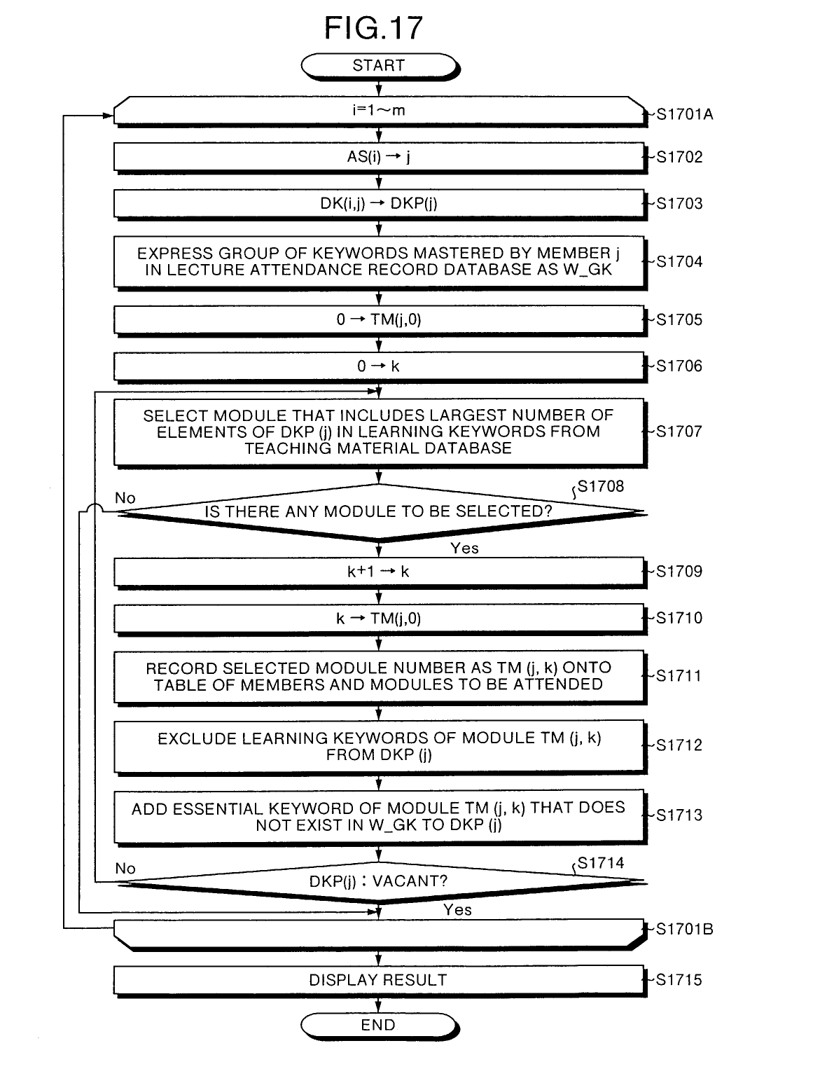

The contents of setting a module lecture attendance plan for each member requiring skill enhancement at step S1404 in FIG. 14 will be explained below. The setting of the module lecture attendance plan is also automatically processed by the present system. FIG. 17 is a flowchart which shows the contents of the module lecture attendance planning processing for a member requiring skill enhancement in the personnel skill enhancement plan supporting apparatus according to the embodiment of the present invention.

In the flowchart shown in FIG. 17, first, at step S1702, “j” corresponding to a skill number “i” is read from the table of members assigned to skills 124 (step S1702). Then, difference keywords corresponding to the above “i” and “j” are read from the table of difference keywords 122, and these difference keywords are expressed as DKP (j) (step S1703). DKP (j) is an element in the table of keywords yet to be mastered by members 113 shown in FIG. 7. This DKP (j) shows a remaining after subtracting keywords mastered as a result of the member j attending a module lecture, from the difference keywords. Therefore, modules are searched for until this DKP (j) becomes vacant.

A group of the keywords mastered by the member j in the lecture attendance record database 106 shown in FIG. 4 is expressed as W_GK (step S1704). In the table of members and modules to be attended 112 shown in FIG. 6, a column number 0 shows the number of modules of which lectures should be attended. “0” is set to TM (j, 0) corresponding to the number of modules (step S1705), and 0 is set to a column number k (step S1706). The element in this table of members and modules to be attended 112 is a module number of a module of which lecture the member j should attend. TM (j, 0) represents the number of modules of which lectures should be attended.

Thereafter, a module that includes the largest number of elements of DKP (j) in the learning keywords is selected from the teaching material database 104 (step S1707). However, a module that has already been selected for the member j is excluded. When there is no module to be selected (No at step S1708), no processing is carried out, and the next necessary skill is searched for.

On the other hand, when there is a module to be selected at step S1708 (Yes at step S1708), one column number is added (step S1709), and k is set to TM (j, 0) (step S1710). The selected module number is recorded as this TM (j, k) onto the table of members and modules to be attended 112 (step S1711).

Thereafter, the learning keywords of the module TM (i, j) are excluded from DKP (j) (step S1712). Next, an essential keyword of the module TM (j, k) that does not exist in W_GK is added to DKP (j) (step S1713). Then, it is determined whether DKP (j) is vacant or not (step S1714). When DKP (j) is not vacant (No at step S1714), the process returns to step S1707. The processing at step S1707 to step S1714 is carried out repeatedly.

On the other hand, when DKP (j) is vacant (Yes at step S1714), the next necessary skill is searched for. In this manner, the processing at step S1702 to step S1714 is repeatedly carried out for 1 to m (step S1701A to step S1701B).

In the manner as described above, mastered keywords are read from the lecture attendance record (the lecture attendance record database 106) for each member assigned to each skill (the table of members assigned to skills 124) (first processing). A module that includes a largest number of difference keywords required for this member in the learning keywords is selected from the teaching material database 104 (second processing). Keywords to be mastered by the module that has been selected in the second processing, are subtracted from the difference keywords (third processing). The second processing and the third processing are repeated until when the difference keywords become vacant (fourth processing). When the difference keywords have become vacant, a module of which lecture should be attended is determined.

Thereafter, the contents of the result are stored into the table of lecture modules to be attended 114, the stored result is displayed (step S1715), and the series processing is finished. There are the following four methods for displaying the result.

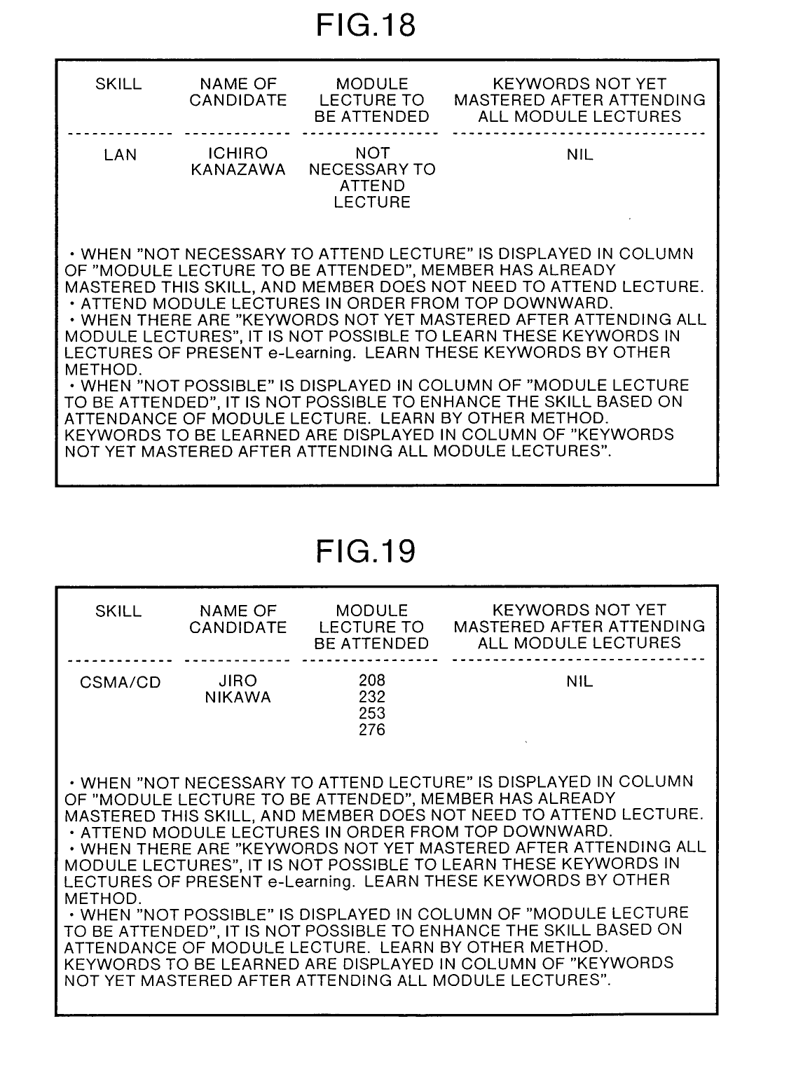

(1) When TM (j, 0) is 0 and DKP (j) is vacant, the member j does not need to take skill enhancement lectures. FIG. 18 shows one concrete example of a screen displaying a determination result of module lecture attendance.

(2) When TM (j, 0) is larger than 0, DKP (j) is vacant, and a value of TM (j, 0) is q, the member j can achieve predetermined skill enhancement through attendance of lectures of modules in the reverse order in the table from TM (j, q) to TM (j, 1). FIG. 19 shows one concrete example of a screen displaying a determination result of module lecture attendance.

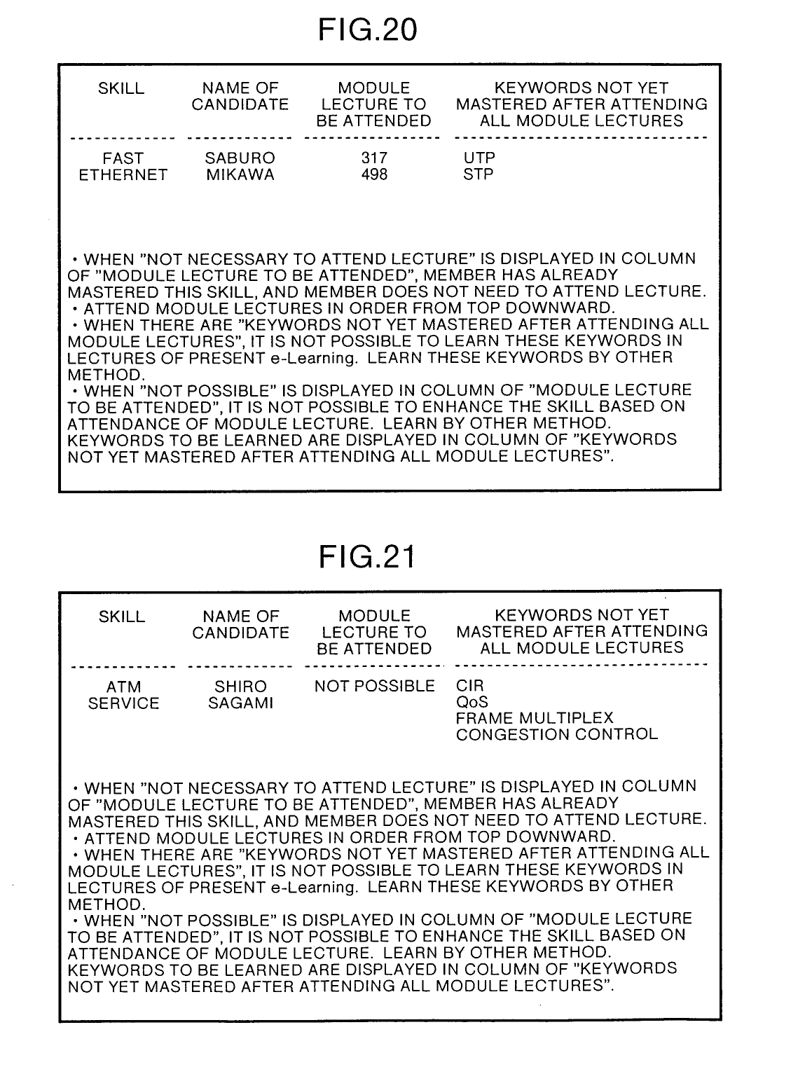

(3) When TM (j, 0) is larger than 0, DKP (j) is not vacant, and a value of TM (j, 0) is q, the member j achieves skill enhancement through attendance of lectures of modules in the reverse order in the table from TM (j, q) to TM (j, 1). However, the keywords of DKP (j) remain as keywords not yet mastered. Therefore, this message is displayed to prompt the member to take other measures. FIG. 20 shows one concrete example of a screen displaying a determination result of module lecture attendance.

(4) When TM (j, 0) is 0 and DKP (j) is not vacant, the member j is not possible to enhance skill by attending the module. Therefore, this message is displayed to prompt the member to take other measures. FIG. 21 shows one concrete example of a screen displaying a determination result of module lecture attendance.

[Outline of Lecture Attendance Simulation]

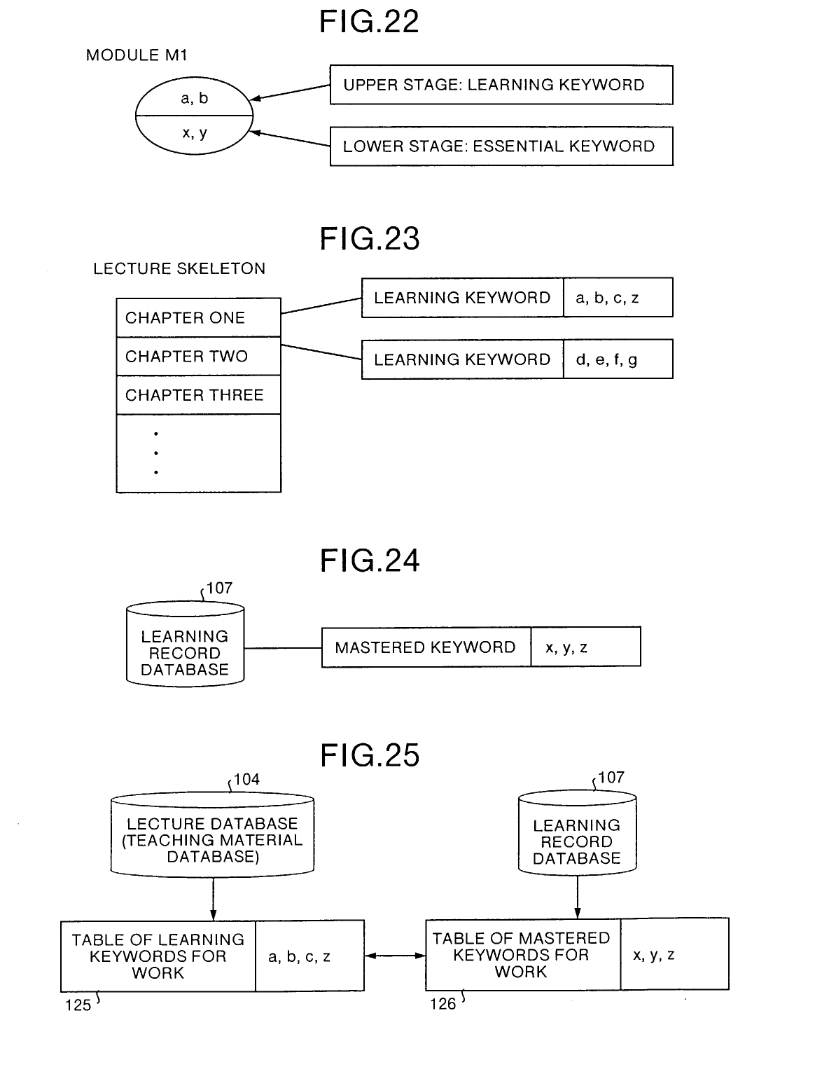

An outline of a lecture attendance simulation that simulates a lecture attendance time and a lecture fee will be explained. FIG. 22 to FIG. 31 are explanatory diagrams which show the outlines of the lecture attendance simulation in the personnel skill enhancement plan supporting apparatus according to the embodiment of the present invention.

In FIG. 22, in order to facilitate the understanding, each module in the module database 109 is expressed as follows. As shown in FIG. 22, the upper stage of each module shows learning keywords (a, b), and the lower stage shows essential keywords (x, y) respectively. A teaching material is thus prepared using a small unit as a module. For each module, learning keywords that are obtained by learning and essential keywords that are required for the learning, are defined.

Referring to FIG. 23, in a lecture skeleton, learning keywords to be learned in a chapter are defined for each chapter. As shown in FIG. 23, learning keywords in chapter one are a, b, c, and z, and learning keywords in chapter two are d, e, f, and g. Referring to FIG. 24, knowledge already obtained by a lecture attendant in the past is stored as mastered keywords (x, y, z) in the learning record database 107.

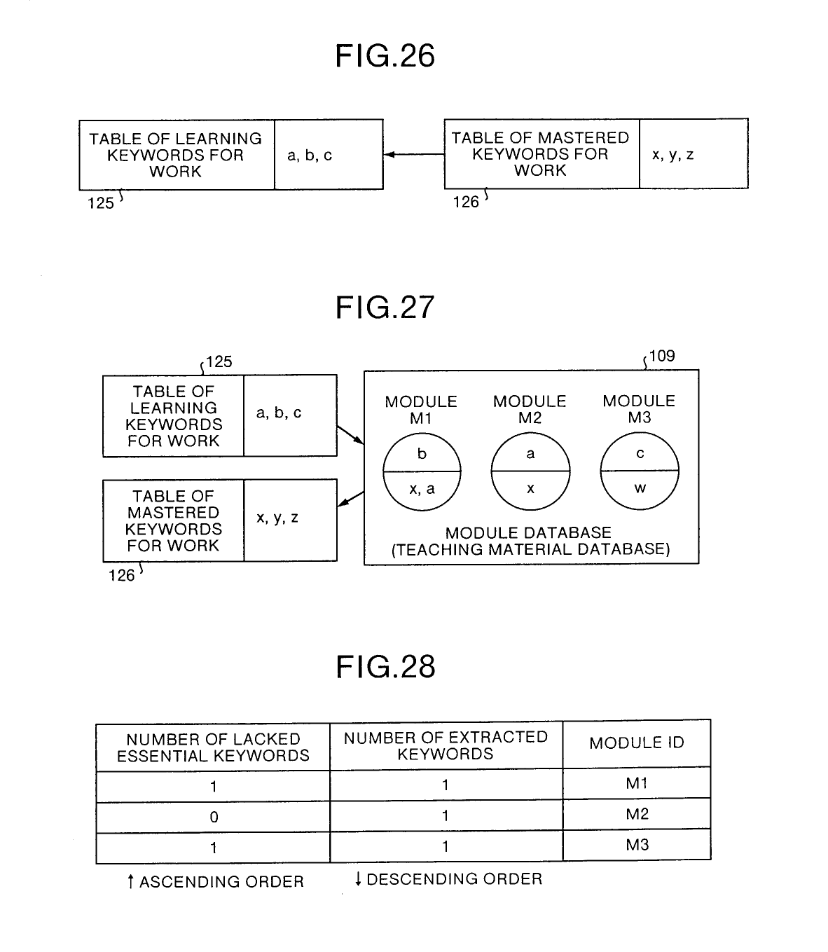

As shown in FIG. 25, the learning keywords (a, b, c, z) in a chapter to be learned are copied from the lecture database 104 onto the table of learning keywords for work 125. At the same time, the mastered keywords (x, y, z) based on the learning record of a lecture attendant are copied from the learning record database 107 onto the table of mastered keywords for work 126. Then, as shown in FIG. 26, a keyword (z) that exists in the table of mastered keywords for work 126 is deleted from the table of learning keywords for work 125. As a result, the table of learning keywords for work 125 has three keywords “a, b, c”.

Next, as shown in FIG. 27, a module that has learning keywords the same as the keywords (a, b, c) in the table of learning keywords for work 125 is extracted from the module database 109. The essential keywords of the extracted module are compared with the keywords (x, y, z) in the table of mastered keywords for work 126, and the candidate record as shown in FIG. 28 is prepared. Referring to FIG. 28, the mastered keywords for work are compared with the essential keywords of each module to store the number of lacked keywords into the column of the number of lacked essential keywords. For a module M1, the essential keywords are “x, a”. On the other hand, the table of mastered keywords for work 126 has the keywords “x, y, z”. Therefore, the essential keyword “x” exists, but “a” does not exist in the table of mastered keywords for work 126. Consequently, the number of lacked essential keywords becomes “1”.

For a module M2, “x” exists in the table of mastered keywords for work 126, like for the module Ml. Therefore, the number of lacked essential keywords becomes “0”. For a module M3, “w” does not exist in the table of mastered keywords for work 126. Therefore, the number of lacked essential keywords becomes “1”.

The keywords in the table of learning keywords for work 125 are compared with the learning keywords of each module, and the number of coincident keywords is stored into the column of the number of extracted keywords. For the module Ml, there exists only one learning keyword “b”, but this “b” exists in the table of learning keywords for work 125. Therefore, the number of extracted keywords becomes “1”. For the module M2, the number of extracted keywords becomes “1”, and for the module M3, the number of extracted keywords becomes “1”, like for the module Ml.

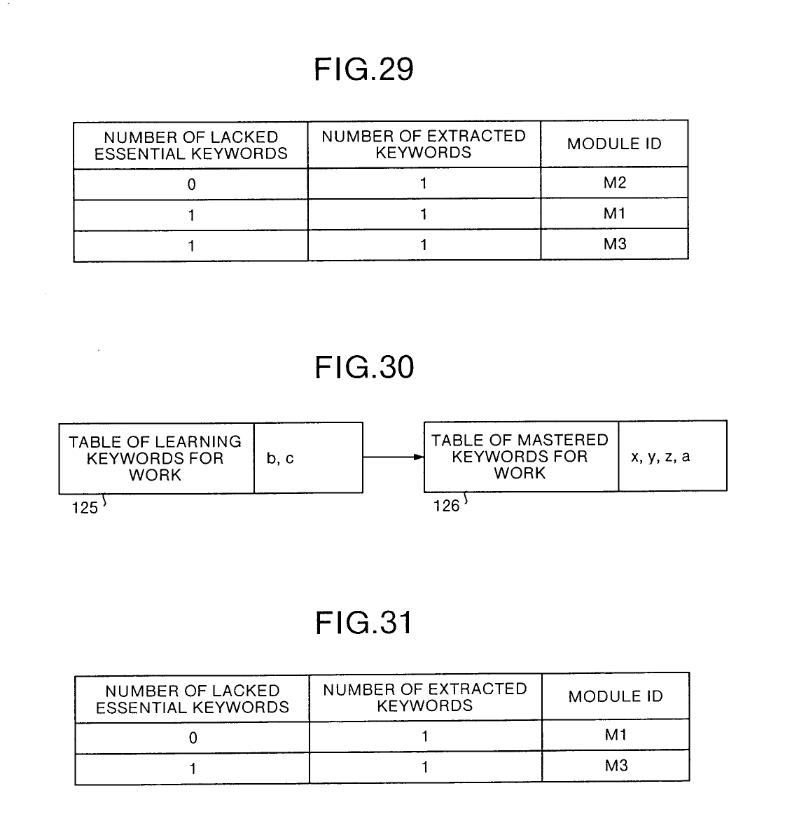

Next, the numbers of lacked essential keywords are sorted first in the ascending order, and the numbers of extracted keywords are sorted second in the descending order. FIG. 29 shows a result of the sorting. In FIG. 29, the module M2 that comes first has “0” as the number of lacked essential keywords. Therefore, it is possible to learn the module M2 at any moment.

Assuming that the module M2 has been learned, time and fee are registered into the table of learning modules 127 (refer to FIG. 40 to be described later). Then, as shown in FIG. 30, the learning keyword “a” is deleted from the table of learning keywords for work 125, and this “a” is added to the mastered keywords for work. In this status, the work shown in FIG. 27 is carried out again to prepare a candidate record similar to that shown in FIG. 28. Then, in a similar manner, the numbers of lacked essential keywords of this candidate record are sorted in the ascending order, and the numbers of extracted keywords are sorted in the descending order to obtain a candidate record as shown in FIG. 31. In FIG. 31, the module M1 has “0” as the number of lacked essential keywords. Therefore, it is possible to learn the module M1 at any moment.

When a similar processing is repeated, the remaining candidate is only the module M3 that has “1” as the number of lacked essential keywords. In this case, a lacked essential keyword “w” is added to the table of learning keywords for work 125, and a module that has “w” as the learning keyword is searched for. When there is a further lacked essential keyword, this lacked essential keyword is added to the learning keywords for work, and a module that has this keyword as the learning keyword is searched for, in a similar manner. When there is no more keyword to be added after repeating the above processing, or when the number of repetition exceeds a predetermined number, a learning keyword that has not yet been mastered is treated compulsively as a mastered keyword. Then, the processing is repeated.

When a module that has learning keywords defined in the skeleton and that satisfies the condition of essential keywords and mastered keywords based on the above processing, is provided, it is possible to learn modules without duplication of mastered knowledge. When the essential knowledge is lacked, it is possible to take the lacked contents from other lectures. This system can provide skills that match the individuals. On the other hand, there arises such a problem that the lecture attendance time or the lecture attendance period is different, although the attendance on the same lecture has been applied for. In addition, there arises a question about whether the lecture attendance fee matches the contents of the lecture or not if the lecture fee is fixed.

Therefore, the above work is repeated for each chapter. At the point of time when the whole lecture has been finished, evaluation data such as a total time and a total fee is prepared based on the table of learning modules 127. Before the lectures are started, a simulation is carried out using keywords, and a result of a forecast on the lecture attendance time and fee is fed back to a lecture attendant. Based on this result, the lecture attendant can attend lectures that suit the attendant, by repeating this simulation.

[Contents of the Whole Processing for the Lecture Attendance Simulation]

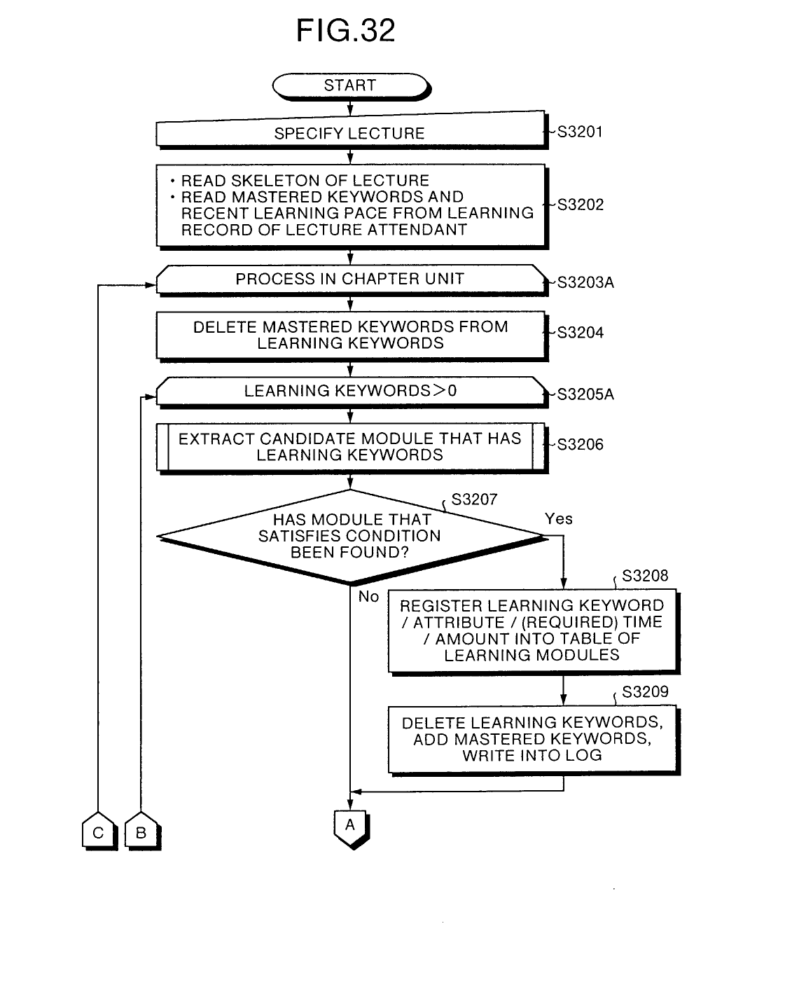

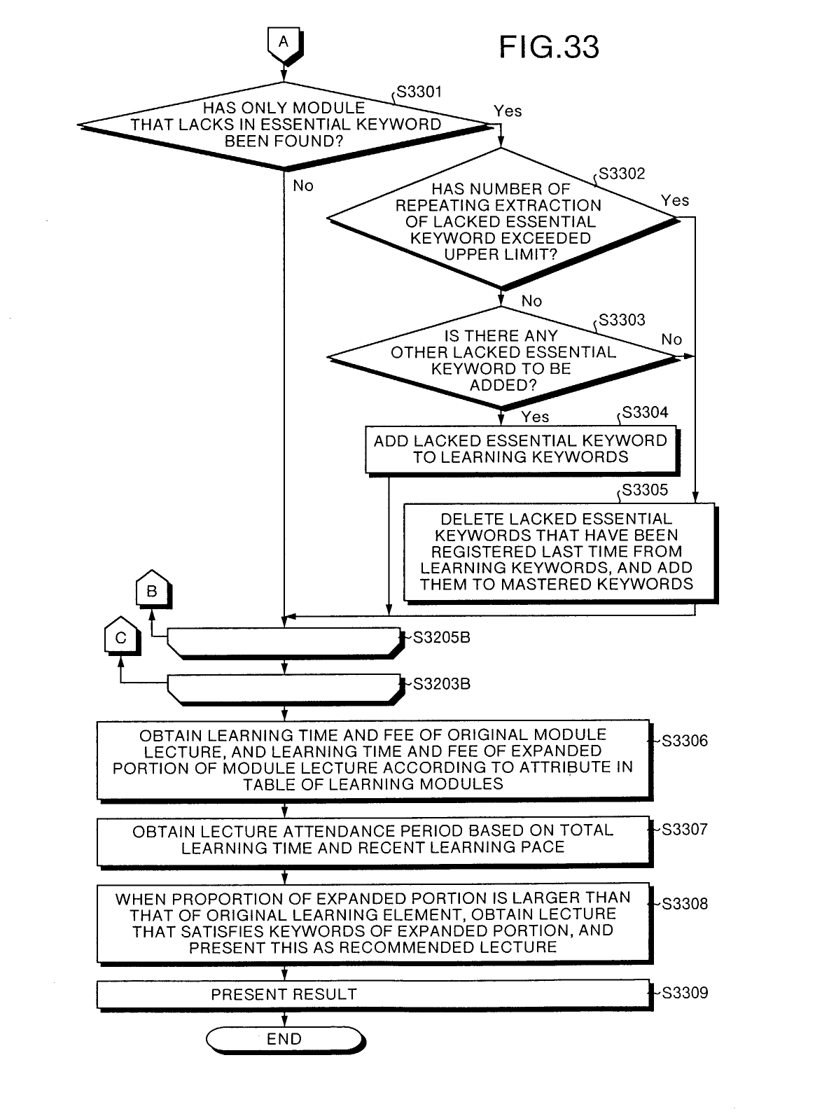

The contents of the whole processing for the lecture attendance simulation will be explained. This whole processing is carried out automatically by the present system. FIG. 32 and FIG. 33 are flowcharts which show the contents of the whole processing of the lecture attendance simulation according to the embodiment of the present invention. Referring to the flowchart shown in FIG. 32, first, a lecture attendant specifies a lecture (step S3201).

Next, the skeleton of the lecture is read, and mastered keywords and recent learning pace of the lecture attendant are read from the learning record of the lecture attendant (step S3202). FIG. 34 is an explanatory diagram which shows a part of the data layout of the lecture database 108, and this shows the skeleton of the lecture. FIG. 35 is an explanatory diagram which shows a part of the data layout of the table of learning keywords for work 125. The processing of reading the skeleton of the lecture includes the processing of extracting learning keywords from the lecture database 108 and writing (copying) the extracted learning keywords onto the table of learning keywords for work 125.

As shown in FIG. 35, in the table of learning keywords for work 125, items of “attribute”, “deletion flag”, and “number of repetition at the addition time” are prepared for each learning keyword. When the “attribute” is “0”, this shows that this learning keyword has been copied from the lecture skeleton. When the “attribute” is “1”, this shows that this learning keyword is a lacked essential keyword. When the “deletion flag” is “0”, this shows that the keyword is valid. When the “deletion flag” is “1”, this shows that the keyword has been deleted because this is a mastered keyword, or the keyword has been deleted as this keyword has been learned.

FIG. 36 is an explanatory diagram which shows a part of the data layout of the learning record database 107. This learning record database 107 stores items of “individual ID”, “recent learning pace”, and “mastered keywords”. The item of “mastered keywords” stores for each keyword, a date and time of registration, and information relating to a learning method (“0” shows that the keyword has been-mastered based on a self-learning, and “1” shows that the keyword has been registered based on a self-application). The “recent learning pace” shows a learning pace during a recent few months (a time that can be spent for the learning during a predetermined time period (one day, for example)). FIG. 37 is an explanatory diagram which shows a part of the data layout of the table of mastered keywords for work 126.

The processing of reading mastered keywords and recent learning pace of a lecture attendant from the learning record of the lecture attendant includes the processing of extracting information relating to the mastered keywords and the recent learning pace of the lecture attendant from the learning record database 107, and writing (copying) the information relating to the mastered keywords (including the information relating to the date and time of registration and the learning method for each mastered keyword) onto the table of mastered keywords for work 126.

As shown in FIG. 37, in the table of mastered keywords for work 126, items of “date and time of registration” and “learning method” are provided for each mastered keyword. When the “learning method” is “0”, this shows that the keyword has been mastered by learning in the past. When the “learning method” is “1”, this shows that the keyword has been registered based on a self-application. When the “learning method” is “2”, this shows that the keyword has been mastered by learning this time. When the “learning method” is this shows that a learning keyword not yet mastered has been treated compulsively as a mastered keyword.

Referring back to FIG. 32, at step S3203, the processing is carried out for each chapter. The processing is started from chapter one. The table of learning keywords for work 125 is compared with the table of mastered keywords for work 126, and mastered keywords are deleted from learning keywords (step S3204). Next, it is determined whether the number of learning keywords is larger than 0 or not, that is, whether the number of learning keywords is 0 or not (step S3205). When the number of learning keywords is not 0, a candidate module having a learning keyword is extracted (step S3206).

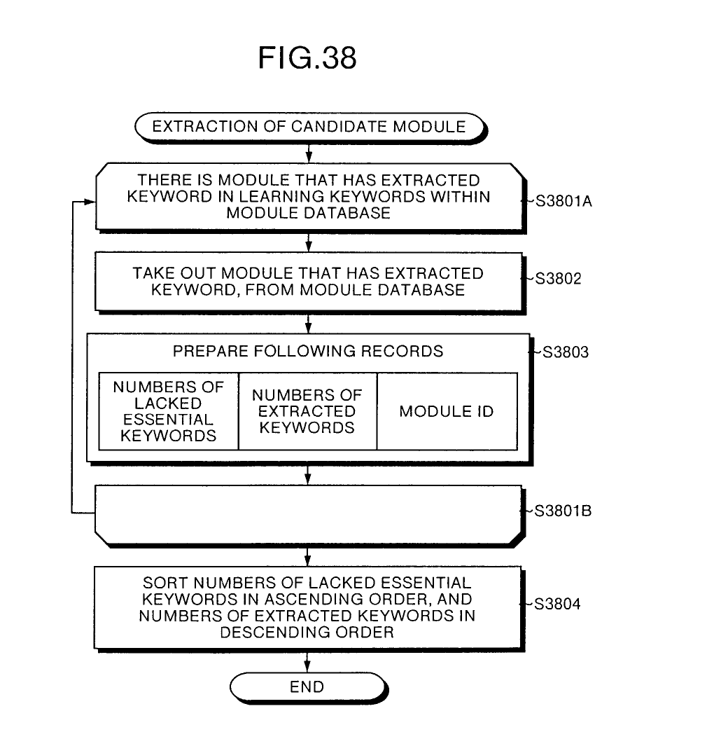

The learning keyword in the table of learning keywords for work will be called an extracted keyword. FIG. 38 is a flowchart which shows the contents of the candidate module extraction processing at step S3206. FIG. 39 is an explanatory diagram which shows a part of the data layout of the module database 109. The module database 109 stores information relating to learning time, and a fee, in addition to learning keywords, and essential keywords. Referring to FIG. 38, first, it is determined whether or not there is a module that has an extracted keyword in the learning keywords within the module database 109 (step S3801). When there is a module that has an extracted keyword in the learning keywords, the module that has the extracted keyword is taken out from the module database 109 (step S3802).

A candidate record as shown in FIG. 28 is prepared for the module that has been taken out (step S3803). The processing of extracting a module and preparing a candidate record (steps S3802 and S3803) is carried out repeatedly until there is no more module that has an extracted keyword in the learning keywords (step S3801A to S3801B). When there is no more module that has an extracted keyword in the learning keywords, the numbers of lacked essential keywords are sorted first in the ascending order, and the numbers of extracted keywords are sorted second in the descending order, as shown in FIG. 29 (step S3804). The candidate module extraction processing at step S3206 is finished and the process proceeds to step S3207 shown in FIG. 32.

Referring back to FIG. 32 again, at step S3207, it is determined whether a module that satisfies the condition, that is, a module that has “0” as the number of lacked essential keywords, has been found or not (step S3207). When a module that satisfies the condition has been found (Yes at step S3207), learning keyword, attribute, (required) time, and fee are registered into the table of learning modules 127 (step S3208). FIG. 40 is an explanatory diagram which shows a part of the data layout of the table of learning modules 127.

In FIG. 40, items “learning keywords”, “attribute (standard/expansion)”, “time”, and “fee” are provided for each module. When the “attribute (standard/expansion)” is “0”, this shows that the module is a standard module. When the “attribute (standard/expansion)” is “1”, this shows that the module is an expanded module, that is, a module that satisfies the lacked keyword.

Next, learning keywords are deleted from the table of learning keywords for work 125 (“1” is set to the “deletion flag”). At the same time, mastered keywords are added to the table of mastered keywords for work 126, and are written into the log (step S3209). The writing into the log includes the writing of when the module relating to the keyword has been learned (registered) and the setting “2” to the “learning method” in the table of mastered keywords for work 126. Then, the process proceeds to step S3301 shown in FIG. 33. When a module that satisfies the condition has not been found at step S3207 (No at step S3207), no processing is carried out, and the process proceeds to step S3301 shown in FIG. 33.

At step S3301 in the flowchart shown in FIG. 33, it is determined whether only a module that lacks in the essential keyword has been found or not (step S3301). When only a module that lacks in the essential keyword has not been found (No at step S3301), no processing is carried out, and the process proceeds to step S3205B. On the other hand, when only a module that lacks in the essential keyword has been found (Yes at step S3301), it is determined whether the number of repeating the extraction of a lacked keyword has exceeded an upper limit or not (step S3302). When the number of repeating the extraction of a lacked keyword has exceeded the upper limit (Yes at step S3302), the process proceeds to step S3305.

On the other hand, when the number of repeating the extraction of a lacked keyword has not exceeded the upper limit at step S3302 (No at step S3302), it is determined whether there is other lacked essential keyword to be added or not (step S3303) When there is no other lacked essential keyword to be added (No at step S3303), the process proceeds to step S3305. On the other hand, when there is other lacked essential keyword to be added (Yes at step S3303), the lacked essential keyword is added to the learning keywords (step S3304), and the process proceeds to step S3205B.

At step S3305, lacked essential keywords that have been registered last time are deleted from the learning keywords in the table of learning keywords for work 125, and are added to the mastered keywords in the table of mastered keywords for work 126. The “learning method” is set with “3 (compulsive)”, and then, the process proceeds to step S3205B.

The processing at step S3206 to step S3305 is carried out repeatedly until the number of learning keywords becomes 0 (step S3205A to step S3205B). When the processing at step S3205 to step S3305 has been finished for chapter one, the same processing is carried out for chapter two (step S3203A to step S3203B). When the processing has been finished for all chapters, the learning time and fee of the original module lecture, and the learning time and fee of the expanded portion are obtained according to the attribute in the table of learning modules 127 (step S3306).

The lecture attendance period is obtained based on the total learning time and the recent learning pace (step S3307). The table of learning modules 127 presents a total time and a total fee required for learning the learning keywords of the original lecture (skeleton), and a total time and fee required for the expanded portion to learn the lacked keywords. The required time is divided by the recent lecture attendance pace to present an estimated number of days required for finishing the lectures. For example, when a total leaning time is thirty hours, and when an average learning time per day of the lecture attendant is two hours, the lecture attendance period becomes fifteen days.

When the proportion of the expanded portion is larger than that of the original learning element, a lecture that satisfies the keywords of the expanded portion is obtained, and this is presented as a recommended lecture (step S3308) In other words, when the time or fee required for the expanded portion exceeds a certain rate of the total time or fee, a lecture that has many keywords included in the expanded portion is searched for, and this is presented as a recommended lecture. When there is a recommended lecture, the lecture attendant can carry out a simulation again based on this lecture, and select a lecture that satisfies the attendant. The contents of the result (of the simulation) are stored into the table of lecture modules to be attended 114. The stored contents are displayed to make presentation to the lecture attendant (step S3309), and the series of processing finishes there.

As explained above, according to the present embodiment, by selecting a target member based on a difference between the mastered keywords and the keywords to be mastered, it is possible to obtain an optimum solution (a pseudo optimum solution in a strict sense) through calculation of only a necessary number of skills. It is also possible to select members based on a pseudo optimum combination of candidates requiring skill enhancement in order to complement skills that are lacked in the organization. It is further possible to select and order teaching material modules that the candidates should attend. These operations can be simultaneously executed without failing to calculate complicated combinations. It is also possible to provide information such as learning time, fee, suitability and unsuitability of lecture attendance, and other recommended lectures.

The personnel skill enhancement plan supporting method in the present embodiment may be a computer-readable program that is prepared in advance. It is possible to realize the method by executing the program with a computer such as a personal computer and a workstation. This program is recorded onto a computer-readable recording medium such as a hard disk (HD), a flexible disk (FD), a CD-ROM, an MO, or a DVD. The program is executed by the computer by reading the program from the recording medium. This program may be a transmission medium that can be distributed via a network like the Internet.

As explained above, according to the present invention, by selecting a target member based on a difference between the mastered keywords and the keywords to be mastered, it is possible to obtain an optimum solution through calculation of only a necessary number of skills. Further, it is possible to provide information such as learning time, fee, suitability and unsuitability of lecture attendance, and other recommended lectures. Therefore, there is an effect that it is possible to obtain the personnel skill enhancement plan supporting method, personnel skill enhancement plan supporting program, and the personnel skill enhancement plan supporting apparatus capable of efficiently and easily extracting most suitable personnel whose skills are to be built up from among a plurality of members and capable of extracting optimum teaching materials to be learned.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A personnel skill enhancement plan supporting method executed by a computer system, the method comprising:
when information relating to a skill has been input,
a difference keyword extracting step of extracting a difference keyword as a keyword indicating a not-yet-mastered skill that is a keyword linked with the skill relating to the information but not a keyword linked with a skill already mastered by a target member to be extracted; and
a target member information extracting step of extracting information relating to a target member who has a smallest number of difference keywords that have been extracted at the difference keyword extracting step.

2. The personnel skill enhancement plan supporting method according to claim 1, further comprising:
a teaching material information extracting step of extracting information relating to a teaching material linked with keywords that coincide with the whole or a part of the difference keywords extracted at the difference keyword extracting step.

3. The personnel skill enhancement plan supporting method according to claim 2, further comprising:
an outputting step of outputting, for each target member, information relating to the member extracted at the target member information extracting step, and information relating to the teaching material extracted at the teaching material information extracting step.

4. A personnel skill enhancement plan supporting method executed on a computer system, the computer system including
a skill keyword group storing unit that stores a keyword group relating to a skill, and
a mastered skill information storing unit that stores information relating to a skill already mastered by a target member, the method comprising:
when information relating to a skill has been input,
a difference keyword extracting step of extracting keywords linked with the skill relating to the input information by referring to the skill keyword group storing unit, and keywords linked with information relating to the skill stored in the mastered skill information storing unit, and taking a difference between these keywords, as a difference keyword that is a keyword indicating a not-yet-mastered skill; and
a target member information extracting step of extracting information relating to a target member who has a smallest number of difference keywords that have been extracted at the difference keyword extracting step.

5. The personnel skill enhancement plan supporting method according to claim 4, further comprising:
a teaching material information extracting step of extracting information relating to a teaching material linked with keywords that coincide with the whole or a part of the difference keywords extracted at the difference keyword extracting step.

6. The personnel skill enhancement plan supporting method according to claim 5, further comprising:
an outputting step of outputting, for each target member, information relating to the member extracted at the target member information extracting step, and information relating to the teaching material extracted at the teaching material information extracting step.

7. A personnel skill enhancement plan supporting method executed on a computer system, the computer system including
a difference keyword extracting unit that extracts, for each target member, a difference keyword as a keyword indicating a not-yet-mastered skill that is a keyword linked with a skill relating to input information but not a keyword linked with a skill already mastered by the member to be extracted, and
a target member information extracting unit that extracts information relating to a member who has a smallest number of difference keywords that have been extracted by the difference keyword extracting unit, the method comprising:
a difference keyword extracting step of extracting, for each target member, the difference keyword that is a keyword linked with a skill relating to input information but not a keyword linked with a skill already mastered by the member to be extracted; and
a target member information extracting step of extracting information relating to a target member who has a smallest number of difference keywords that have been extracted at the difference keyword extracting step.

8. The personnel skill enhancement plan supporting method according to claim 7, further comprising:
a teaching material information extracting step of extracting information relating to a teaching material linked with keywords that coincide with the whole or a part of the difference keywords extracted at the difference keyword extracting step.

9. The personnel skill enhancement plan supporting method according to claim 8, further comprising:
an outputting step of outputting, for each target member, information relating to the member extracted at the target member information extracting step, and information relating to the teaching material extracted at the teaching material information extracting step.

10. A personnel skill enhancement plan supporting method executed on a computer system, the computer system including a skill keyword group storing unit that stores a keyword group relating to a skill,
a mastered skill information storing unit that stores information relating to a skill already mastered by a target member,
a difference keyword extracting unit that, when information relating to a skill has been input, extracts keywords linked with the skill relating to the input information by referring to the skill keyword group storing unit, and keywords linked with information relating to the skill stored in the mastered skill information storing unit, and takes a difference between these keywords, as a difference keyword that is a keyword indicating a not-yet-mastered skill, and
a target member information extracting unit that extracts information relating to a target member who has a smallest number of difference keywords that have been extracted by the difference keyword extracting unit, the method comprising:
when information relating to a skill has been input,
a difference keyword extracting step of extracting keywords linked with the skill relating to the input information by referring to the skill keyword group storing unit, and keywords linked with information relating to the skill stored in the mastered skill information storing unit, and taking a difference between these keywords, as the difference keyword; and
a target member information extracting step of extracting information relating to a target member who has a smallest number of difference keywords that have been extracted at the difference keyword extracting step.

11. The personnel skill enhancement plan supporting method according to claim 10, further comprising:
a teaching material information extracting step of extracting information relating to a teaching material linked with keywords that coincide with the whole or a part of the difference keywords extracted at the difference keyword extracting step.

12. The personnel skill enhancement plan supporting method according to claim 11, further comprising:
an outputting step of outputting, for each target member, information relating to the member extracted at the target member information extracting step, and information relating to the teaching material extracted at the teaching material information extracting step.

13. A personnel skill enhancement plan supporting method executed on a computer system, the method comprising:
when information relating to a skill has been input,
a difference keyword extracting step of extracting a difference keyword as a keyword indicating a not-yet-mastered skill that is a keyword linked with the skill relating to the information but not a keyword linked with a skill already mastered by a target member to be extracted;
a module extracting step of extracting a module linked with keywords that coincide with the whole or a part of the difference keywords extracted at the difference keyword extracting step, out of information relating to modules obtained by subdividing a teaching material;
an essential keyword extracting step of extracting an essential keyword linked with contents which are supposed to be learned in advance in order to learn contents of the module extracted at the module extracting step;
a lacked essential keyword extracting step of extracting a lacked essential keyword as a keyword indicating a not-yet-mastered essential skill that is an essential keyword extracted at the essential keyword extracting step but not a keyword linked with the skill already mastered by the member; and
a learnable module extracting step of extracting the module as a learnable module when the number of lacked essential keywords extracted at the lacked essential keyword extracting step is zero.

14. The personnel skill enhancement plan supporting method according to claim 13, further comprising:
a determining step of determining at least one of a lecture attendance fee and a lecture attendance period of the target member based on the learnable module extracted at the learnable module extracting step.

15. The personnel skill enhancement plan supporting method according to claim 13, wherein when there are a plurality of modules in which the number of lacked essential keywords extracted at the lacked essential keyword extracting step is zero among the modules extracted at the module extracting step, the learnable module extracting step comprises:
extracting a module that includes a largest number of difference keywords that have been extracted at the difference keyword extracting step.

16. A personnel skill enhancement plan supporting program executed on a computer, the program comprising:
when information relating to a skill has been input,
a difference keyword extracting step of extracting, for each target member, a difference keyword as a keyword indicating a not-yet-mastered skill that is a keyword linked with the skill relating to the information but not a keyword linked with a skill already mastered by the member to be extracted; and
a target member information extracting step of extracting information relating to a target member who has a smallest number of difference keywords that have been extracted at the difference keyword extracting step.

17. The personnel skill enhancement plan supporting program according to claim 16, further comprising:
a teaching material information extracting step of extracting information relating to a teaching material linked with keywords that coincide with the whole or a part of the difference keywords extracted at the difference keyword extracting step.

18. The personnel skill enhancement plan supporting program according to claim 17, further comprising:
an outputting step of outputting, for each target member, information relating to the target member extracted at the target member information extracting step, and information relating to the teaching material extracted at the teaching material information extracting step.

19. A personnel skill enhancement plan supporting program executed on a computer, the program comprising:
when information relating to a skill has been input,
a difference keyword extracting step of extracting a difference keyword as a keyword indicating a not-yet-mastered skill that is a keyword linked with the skill relating to the information but not a keyword linked with a skill already mastered by a target member to be extracted;
a module extracting step of extracting a module linked with keywords that coincide with the whole or a part of the difference keywords extracted at the difference keyword extracting step, out of the information relating to modules obtained by subdividing a teaching material;
an essential keyword extracting step of extracting an essential keyword linked with contents which are supposed to be learned in advance in order to master contents of the module extracted at the module extracting step;
a lacked essential keyword extracting step of extracting a lacked essential keyword as a keyword indicating a not-yet-mastered essential skill that is an essential keyword extracted at the essential keyword extracting step but not a keyword linked with the skill already mastered by the member; and
a learnable module extracting step of extracting a module as a learnable module when the number of lacked essential keywords extracted at the lacked essential keyword extracting step is zero.

20. The personnel skill enhancement plan supporting program according to claim 19, further comprising:
a determining step of determining at least one of a lecture attendance fee and a lecture attendance period of the target member based on the learnable module extracted at the learnable module extracting step.

21. The personnel skill enhancement plan supporting program according to claim 19, wherein when there are a plurality of modules in which the number of lacked essential keywords extracted at the lacked essential keyword extracting step is zero, among the modules extracted at the module extracting step, the learnable module extracting step further comprises:
extracting a module that includes a largest number of difference keywords that have been extracted at the difference keyword extracting step.

22. A personnel skill enhancement plan supporting apparatus comprising:
an input unit that inputs information relating to a necessary skill;
a difference keyword extracting unit that extracts, for each target member, a difference keyword as a keyword indicating a not-yet-mastered skill that is a keyword linked with the skill relating to the information received by the input unit but not a keyword linked with a skill already mastered by the member to be extracted; and
a target member information extracting unit that extracts information relating to a target member who has a smallest number of difference keywords that have been extracted by the difference keyword extracting unit.

23. A personnel skill enhancement plan supporting apparatus comprising:
an input unit that inputs information relating to a necessary skill;
a difference keyword extracting unit that extracts a difference keyword as a keyword indicating a not-yet-mastered skill that is a keyword linked with the skill relating to the information input by the input unit but not a keyword linked with a skill already mastered by a target member to be extracted;
a module extracting unit that extracts a module linked with keywords that coincide with the whole or a part of the difference keywords extracted by the difference keyword extracting unit, out of information relating to modules obtained by subdividing a teaching material;
an essential keyword extracting unit that extracts an essential keyword linked with the contents which are supposed to be learned in advance in order to master contents of the module extracted by the module extracting unit;
a lacked essential keyword extracting unit that extracts a lacked essential keyword as a keyword indicating a not-yet-mastered essential skill that is an essential keyword extracted by the essential keyword extracting unit but not a keyword linked with the skill already mastered by the member; and
a learnable module extracting unit that extracts the module as a learnable module when the number of lacked essential keywords extracted by the lacked essential keyword extracting unit is zero.

24. The personnel skill enhancement plan supporting apparatus according to claim 23, wherein when there are a plurality of modules in which the number of lacked essential keywords extracted by the lacked essential keyword extracting unit is zero, among the modules extracted by the module extracting unit, the learnable module extracting unit extracts a module that includes a largest number of difference keywords that have been extracted by the difference keyword extracting unit.
